(19) United States
(12) Patent Application Publication
(10) Pub. No.: US 2018/0063421 A1
(43) Pub. Date: Mar. 1, 2018

(54) WEARABLE CAMERA, WEARABLE CAMERA SYSTEM, AND RECORDING CONTROL METHOD

(71) Applicant: Panasonic Intellectual Property Management Co., Ltd., Osaka (JP)

(72) Inventor: Yasushi YOKOMITSU, Fukuoka (JP)

(21) Appl. No.: 15/684,758

(22) Filed: Aug. 23, 2017

(30) Foreign Application Priority Data
Sep. 1, 2016 (JP) 2016-171304
Dec. 20, 2016 (JP) 2016-247037

(51) Int. Cl. H04N 5/232; H04N 5/76

(52) U.S. Cl. CPC H04N 5/23222; H04N 5/23206; H04N 5/76

(57) ABSTRACT

A wearable camera which is mounted on or belongs to a user is provided with a capture that captures a subject on the front side of the user; a communicator that communicates with a sensor that acquires information on a movement of the user, or an external sensor that acquires information of an activity level of the user; a determiner that determines whether or not a predetermined action is performed by the user based on the information on the movement of the user acquired by the sensor, or the information on the activity level of the user acquired by the communicator; and a recording controller that starts recording of the captured video of the subject captured by the capture in a case where the determiner determines that a predetermined action is performed by the user.

### BACKGROUND

### 1. Technical Field

The present disclosure relates to a wearable camera which controls recording of a video captured by the wearable camera, a wearable camera system, and a recording control method.

### 2. Description of the Related Art

Recently, in order to efficiently assist police officers and security officers with their services, a system in which police officers have a wearable camera mounted on or belongs to a uniform at the time of patrolling, for example, has been examined.

As a related art using a wearable camera, a wearable monitoring camera system disclosed in Japanese Patent Unexamined Publication No. 2006-148842 is exemplified. The wearable monitoring camera system has a configuration in which an image (video) signal and a sound signal from a CCD camera and a microphone which are wearable, and a date and time information signal from a built-in clock are encoded by an encoding server which can be accommodated in a wearable pouch, and then date and time information which is converted into text information is superimposed on a captured image so as to record the aforementioned information.

Here, a case where the wearable camera disclosed in Japanese Patent Unexamined Publication No. 2006-148842 is used by being mounted on a uniform of a police officer as an example of a user is assumed. It is assumed that in the case where the police officer has the aforementioned wearable camera mounted on his or her uniform, upon finding a monitoring subject such as a suspicious person or a stolen car, the police officer presses a recording switch so as to start recording image data (an image signal).

However, for example, in a case where an incident suddenly happens, a police officer is required to promptly take various actions with respect to the incident in consideration that an initial operation or an initial investigation is important. In the configuration disclosed in Japanese Patent Unexamined Publication No. 2006-148842, if the police officer cannot afford to press a recording switch of the wearable camera in a site of an incident and thus forgets to record a video, there may be missing of the recording as a result. That is, there is a problem in that it is not possible to remain recording of an evidence video for a site or a suspect involved in an incident in the wearable camera, and thus the video for the incident site cannot be obtained, a district police office can take quick and appropriate actions with respect to the occurrence of the incident, and thereby early resolution of the incident may become difficult. In addition, if the recording of the evidence video cannot be performed, it is not possible to present sufficient evidence in court afterward, and as a result, there is a possibility of causing a great deal of trouble.

### SUMMARY

The present disclosure is made in consideration of the above described circumstances, and an object thereof is to provide a wearable camera, a wearable camera system, and a recording control method which efficiently assist users with their services by starting recording of a video captured by the wearable camera so as to prevent the recording from missing even if a user does not perform a recording operation in person.

According to an aspect of the present disclosure, there is provided a wearable camera which is mounted on or belongs to a user, the wearable camera including: a capture that captures a subject on the front side of the user; a sensor that acquires information on a movement of the user; a determiner that determines whether or not a predetermined action is performed by the user based on information on the movement of the user acquired by the sensor; and a recording controller that starts recording of a captured video of the subject captured by the capture in a case where the determiner determines that a predetermined action is performed by the user.

According to another aspect of the present disclosure, there is provided a wearable camera system in which a wearable camera which is mounted on or belongs to a user is communicably connected to a server, in which the wearable camera captures a subject on the front side of a user, acquires information on a movement of the user, and transmits the acquired information on the movement of the user to the server, the server receives the information on the movement of the user transmitted from the wearable camera, determines whether or not a predetermined action is performed by the user based on the received information on the movement of the user, and transmits a recording start instruction of a captured video of the subject to the wearable camera in a case where it is determined that a predetermined action is performed by the user, and the wearable camera receives the recording start instruction transmitted from the server, and starts recording of the captured video of the subject in response to the received recording start instruction.

According to still another aspect of the present disclosure, there is provided a recording control method in the wearable camera which is mounted on or belongs to a user, the method including: capturing a subject on the front side of a user; acquiring information on the movement of the user; determining whether or not a predetermined action is performed by the user based on the acquired information on a movement of the user; and starting recording of a captured video of the captured subject in a case where it is determined that a predetermined action is performed by the user.

According to still another aspect of the present disclosure, there is provided a wearable camera which is mounted on or belongs to a user, the wearable camera including: a capture that captures a subject on the front side of the user; a communicator that communicates with an external sensor that acquires information of an activity level of the user; a determiner that determines whether or not a predetermined event occurs based on the information on the activity level of the user received from the external sensor by the communicator; and a recording controller that starts recording of the captured video of the subject captured by the capture in a case where the determiner determines that the predetermined event occurs.

According to still another aspect of the present disclosure, there is provided a wearable camera system in which a wearable camera which is mounted on or belongs to a user and an external sensor that acquires an activity level of the user are communicably connected to each other, in which the wearable camera captures a subject on the front side of the user, the external sensor acquires information on the activity level of the user, and transmits the acquired information on the activity level of the user to the wearable camera, and the wearable camera receives the information on the activity level of the user transmitted from the external sensor, determines whether or not a predetermined event occurs based on the received information on the activity level of the user, and starts recording of a captured video of the subject in a case where it is determined that the predetermined event occurs.

According to another aspect of the present disclosure, there is provided a wearable camera in a wearable camera system in which the wearable camera which is mounted on or belongs to a user, an external sensor that acquires an activity level of the user, and a communication terminal are communicably connected to each other, in which the external sensor acquires information on the activity level of the user, and transmits the acquired information on the activity level of the user to the communication terminal, the communication terminal receives the information on the activity level of the user transmitted from the external sensor, determines whether or not a predetermined event occurs based on received the information on the activity level of the user, and transmits a recording start instruction of a captured video of the subject in a case where it is determined that the predetermined event occurs to the wearable camera, and the wearable camera captures a subject on the front side of the user, receives the recording start instruction transmitted from the communication terminal, starts recording of the captured video of the subject in response to the received recording start instruction, and stops the recording of the captured video of the subject in a case where it is determined that the recording stop is determined by an instruction of the user.

According to the present disclosure, the wearable camera system is capable of efficiently assisting users with their services by starting recording of a video captured by a wearable camera so as to prevent the recording from missing even if a user does not perform a recording operation in person.

### BRIEF DESCRIPTION OF THE DRAWINGS

FIG. 1 is an explanatory diagram illustrating an example of an outline of a wearable camera system of the exemplary embodiment;

FIG. 2 is a diagram illustrating an example of an upper body of a police officer wearing a uniform with a wearable camera of the exemplary embodiment;

FIG. 3 is a front view illustrating an example of a front-side surface of a housing of the wearable camera of the exemplary embodiment;

FIG. 4 is a block diagram specifically illustrating an example of an internal configuration of the wearable camera of the exemplary embodiment;

FIG. 5A is a block diagram specifically illustrating an example of an internal configuration of a back end streaming server of the exemplary embodiment;

FIG. 5B is a block diagram specifically illustrating an example of an internal configuration of a back end server of the exemplary embodiment;

FIG. 5C is a block diagram specifically illustrating an example of an internal configuration of a back end client of the exemplary embodiment;

FIG. 6 is a flowchart specifically illustrating an example of operation procedure of automatic recording in a wearable camera of the exemplary embodiment;

FIG. 7 is a sequence diagram specifically illustrating an example of operation procedure of automatic recording in a wearable camera system of the exemplary embodiment;

FIG. 8 is a diagram illustrating an example of a captured image in a state where a police officer holds his or her pistol;

FIG. 9 is a flowchart specifically illustrating an example of operation procedure of automatic recording in a wearable camera of a modification example;

FIG. 10 is a sequence diagram specifically illustrating an example of operation procedure of automatic recording in a wearable camera system of the modification example;

FIG. 11 is a flowchart specifically illustrating another example of operation procedure of automatic recording in the wearable camera of the modification example;

FIG. 12A is diagram illustrating an outline of a first example of the wearable camera system including wearable camera and an activity meter;

FIG. 12B is diagram illustrating an outline of a second example of the wearable camera system including wearable camera, an activity meter, and a smart phone;

FIG. 13 is a block diagram illustrating an example of internal configuration of the activity meter;

FIG. 14 is a sequence diagram specifically illustrating an example of operation procedure of automatic recording in a wearable camera system of a first example of a second exemplary embodiment;

FIG. 15 is a flowchart specifically illustrating another example of operation procedure of automatic recording in a wearable camera system of a first example of the second exemplary embodiment; and

FIG. 16 is a sequence diagram specifically illustrating an example of operation procedure of automatic recording in a wearable camera system of a second example of the second exemplary embodiment.

### DETAILED DESCRIPTION

Hereinafter, embodiments (hereinafter, referred to as the exemplary embodiment) which specifically disclose a wearable camera, a wearable camera system, and a recording control method according to the present disclosure will be described in detail by properly referring to the drawings. Note that, detailed description more than necessary may be omitted. For example, there may be omitted a detailed description of the already well-known matters and a duplicate description of substantially the same structure. This is to avoid that the following description is unnecessarily redundant, and to facilitate the understanding of those skilled in the art. It should be noted that the inventors of the present disclosure provide the accompanying drawings and the description below so that those skilled in the art fully understand the present disclosure, and do not intend to limit the subject matter described in the claims by these.

### First Embodiment

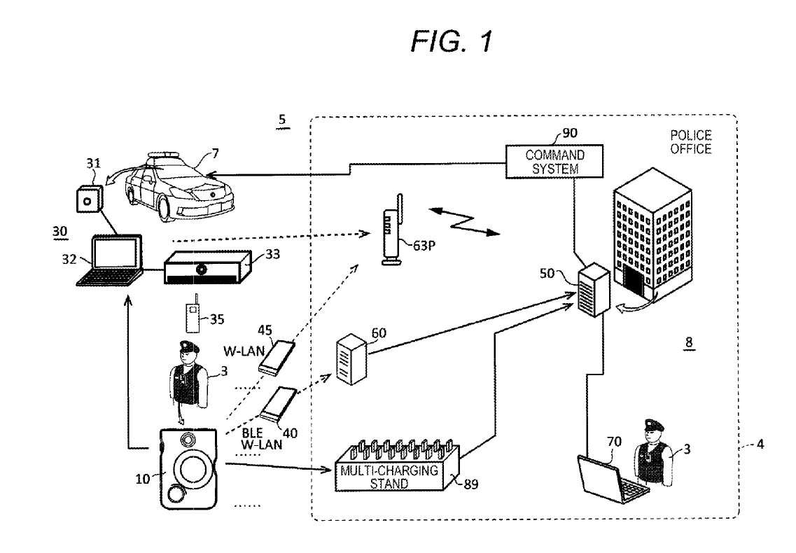

FIG. 1 is an explanatory diagram illustrating an example of an outline of wearable camera system 5 of the exemplary embodiment. Wearable camera system 5 is configured to include on-vehicle camera system (in car video system (ICV)) 30 which is mounted on patrol car 7, wearable camera (body-worn camera (BWC))10 which is mounted or held on a uniform of police officer 3, and in-office system 8 installed in the inside of police office 4.

On-vehicle camera system 30 includes one or more of on-vehicle cameras 31, on-vehicle personal computer (PC) 32, and on-vehicle recorder 33, and captures a video based on captured images of an incident happened when police officers patrol by driving patrol car 7 so as to record the incident. One or more of on-vehicle cameras 31 include one or more cameras among a camera which is installed so as to capture the front side of patrol car 7, and cameras which are respectively installed so as to capture the left, the right, and the rear of patrol car 7. On-vehicle PC 32 controls operations of on-vehicle camera 31 and on-vehicle recorder 33 in accordance with an instruction operated by police officer 3. On-vehicle recorder 33 records video data captured by each of on-vehicle cameras 31 in the time series.

On-vehicle camera system 30 is wirelessly connected to back end server (BES) 50 in in-office system 8 via wireless LAN access point 63P in in-office system 8. on-vehicle camera system 30 selects specific video data from the items of video data recorded in on-vehicle recorder 33, and is capable of transmitting the selected data to back end server 50 via wireless LAN access point 63P. In addition, on-vehicle camera system 30 is communicably connected to wearable camera 10, and records video data captured and sound data collected by wearable camera 10 to on-vehicle recorder 33. In the following description, it is assumed that the sound data includes gunshot when a pistol which belongs to a suspect or a criminal of the incident is shot during the patrol or in the site of the incident, for example.

Wearable camera 10 which is mounted and held on the uniform of police officer 3 who is a user captures atmosphere of the front side of the police officer as a subject, and transmits the captured video data and recorded sound data to on-vehicle camera system 30. Hereinafter, a subject which is supposed to be a capturing target of wearable camera 10 and on-vehicle camera 31 includes not only a person, but also a scene of a site of an incident, crowds gathering near the site (so-called, onlookers), and atmosphere around a capturing position. In addition, police officer 3 belongs police wireless terminal 35 as an example of the wireless communication terminal which receives a command from command system 90. In general, police officer 3 carries police wireless terminal 35 to the site for the activity outside the police office when rapidly dispatching to the site during the patrol or when the incident occurs. Police officer 3 may include smart phone 40 as an example of a communication terminal which is capable of communicating with wearable camera 10. Smart phone 40 has a telephone function and a wireless communication function, and is an example of a portable terminal which is generally used to contact with police office 4 in emergency situations.

Wearable camera 10 is directly connected to back end server 50 via on-vehicle camera system 30, smart phone 40 or wireless local area network (LAN) access point 45 or smart phone 40 such that video data and the sound data can be transmitted to back end server 50. Smart phone 40 is connected to back end server 50 via a mobile communication network or an internet network. Wireless LAN access point 45 is connected to back end server 50 via wire or wireless network (internet network or the like). In addition, when wearable camera 10 is manually attached to multi-charging stand 89 to be described below, the video data and sound data can be transmitted to back end server 50.

In-office system 8 is configured to include back end server 50, back end streaming server (BSS) 65, back end client (BEC) 70, wireless LAN access point 63P, multi-charging stand 89, and command system 90 which are installed in police office 4.

Back end server 50 is configured to include a computer and a storage, and manages an evidence video of the incident. Back end server 50 manages an evidence video of the incident. Back end server 50 has a face recognition function of recognizing a face of a frame of an image constituting a video captured by wearable camera 10 or on-vehicle camera 31, and a sound recognition function of recognizing sound data included in cut-out data (refer to the following description) which is transmitted from wearable camera 10 or on-vehicle camera system 30. In addition, back end server 50 includes sound database (not shown) as an example of the storage in which a predetermined sound data (that is, the sound data of the sound which is likely to be generated during the patrol or the site of the incident) during the patrol or relating to the incident is registered. The predetermined sound data during the patrol or relating to the incident includes, for example, the sound data such as an gunshot when the suspect or the police officer shoots a gun, a sound made by the police officer who is trained in advance to emit when sensing danger during the patrol or when the incident happens, and a sound when the police officer is fell down on the ground or the like (for example, “with a dull thud”). Back end server 50 performs the sound recognition of the sound data included in cut-out data (refer to the following description) which is transmitted from wearable camera 10 or on-vehicle camera system 30, and then collates the sound obtained by the sound recognition with the sound registered in sound database. Note that, the storage which stores sound database may be installed in the inside or the outside of police office 4 as long as the storage is accessible to back end server 50.

Back end streaming server 60 receives the video data which is streaming-distributed from wearable camera 10, and transfers the video data to back end server 50. In addition, back end streaming server 60 may receive the video data which is streaming-distributed from on-vehicle camera system 30 and transfer the video data to back end server 50.

Back end client 70 is configured of PC, and includes a browser or a dedicated application which accesses suspicious person database (not shown) of back end server 50, and detects information on a criminal or the like of the incident so as to display the detected result on a display device (for example, liquid crystal display (LCD) which is previously provided in back end client 70). A person on the wanted list, an ex-convict, or the like is previously registered by corresponding to information for identifying incidents (for example, case number) in the suspicious person database. Back end client 70 is capable of accessing sound database of back end server 50, and searching the information on the incident such as the criminal or the like. Note that, back end client 70 may be installed not only in the inside of police office 4 but also in the outside of the police office 4. Further, back end client 70 may be any one of a thin client PC and a rich client PC.

Wireless LAN access point 63P is wirelessly connected to on-vehicle camera system 30 and wearable camera 10 via wireless LAN (W-LAN), and transfers video data and sound data recorded in on-vehicle camera system 30 and the video data and the sound data recorded in wearable camera 10 to back end server 50.

Multi-charging stand 89 on which wearable cameras 10 which are mounted on or belongs to the uniforms of police officers 3 can be mounted has functions of charging the mounted wearable cameras 10 and transmitting the video data and the sound data stored in wearable camera 10 to back end server 50 by performing wire communication with wearable camera 10. In addition, multi-charging stand 89 is wire-connected to back end server 50 via a universal serial bus (USB) cable.

Command system 90 include a police radio base station apparatus (not shown) as an example of a wireless communication apparatus, is connected to back end server 50, and transmits a command to each district of police office 4. A police wireless system for transferring the command to each police officer is installed in police office 4. In a case where an incident happens, in accordance with an instruction from back end server 50, command system 90 wirelessly transmits various dispatch commands to patrol car 7 in which the police officer who is supposed to dispatch to the site of the incident or police wireless terminal 35 belonging to the police officer such that the police officer rushes to the site of the incident so as to secure the site and a suspect, and support the police officers having arrived at the site. In accordance with the instruction which is input-operated by the police officer, command system 90 may transfer the command to the police officer who is supposed to dispatch to the site of the incident. In addition, command system 90 may not be directly connected to back end server 50, and in a case where the incident happens, command system 90 may wirelessly transmit various dispatch commands to patrol car 7 in which the police officer who is supposed to dispatch to the site of the incident or police wireless terminal 35 from the police radio base station apparatus without depending on back end server 50.

In wearable camera system 5, in a case of using on-vehicle camera system 30, wearable camera 10 is connected to on-vehicle camera system 30 so as to transfer data via near field communication or wire communication by using a signal cable such as USB. The video data captured and the sound data collected by wearable camera 10 is transferred to on-vehicle camera system 30, is played or recorded by on-vehicle camera system 30, and then is transmitted to back end server 50.

On-vehicle camera system 30 records the video data captured by on-vehicle camera 31 and the video data and the sound data captured by wearable camera 10 in on-vehicle recorder 33, cut outs the section of sound collected by wearable camera 10, and transmits the cut-out data including the cut-out sound to back end server 50 via wireless LAN. In a case where a sound having an unexpected large sound volume appears, the cutting out of the sound section is performed so as to include the sound. Note that, the cutting out of the sound section may be performed so as to sample a certain section at a certain cycle. In this case, in the section where there the sound having an unexpected large sound volume does not appear, only a sound having a small volume of the surrounding is cut out.

In wearable camera system 5, in a case of using wearable camera 10 being directly connected to network, wearable camera 10 is connected to wireless LAN access point 45 or smart phone 40 so as to transfer data. For connection between wearable camera 10 and smart phone 40, for example, near field communication such as Bluetooth (trade mark) Low Energy (BLE), or wireless LAN communication by tethering that causes one of wearable camera 10 or smart phone 40 to function as a wireless LAN access point is used. Wearable camera 10 transmits the recorded video data and sound data to back end server 50 via wireless LAN access point 45 or smart phone 40.

Police officer 3 who returns to police office 4 mounts wearable camera 10 on multi-charging stand 89, and multi-charging stand 89 charges wearable camera 10, and can transmit the video data and sound data recorded in wearable camera 10 to back end server 50 via a USB cable.

When receiving video data via back end streaming server 60, or directly from wearable camera 10 or on-vehicle camera system 30, back end server 50 records and stores the transferred video data in the storage. In addition, when receiving the cut-out data from the on-vehicle camera system 30 and wearable camera 10, back end server 50 recognizes the sound included in the cut-out data, collates the recognized sound with the sound registered in the sound database in which the predetermined sound data during the patrol or relating to the incident is registered in advance, and then notifies on-vehicle camera system 30 and wearable camera 10 of the result of the collation.

When police officer 3 requires back end server 50 to perform process of searching the sound involved in the incident by operating back end client 70, and back end server 50 searches the sound registered in suspicious sound database in accordance with the request back end client 70.

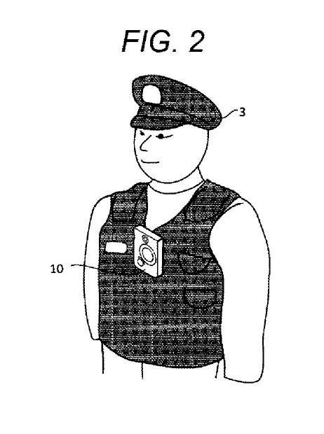

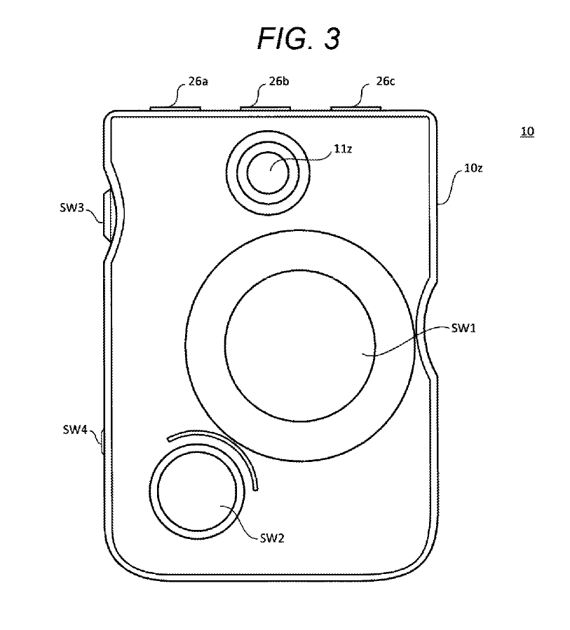

FIG. 2 is a diagram illustrating an example of an upper body of police officer 3 wearing a uniform with wearable camera 10 of the exemplary embodiment. Wearable camera 10 is placed on a front portion of the uniform of police officer 3 so as to capture the front side of police officer 3. For example, wearable camera 10 may be fixed on the front portion in a state of hanging on a string from the neck, or may be fixed on the front portion of the uniform by causing a mounting tool (for example, a mounting clip) attached to the rear surface of housing 10z (refer to FIG. 3) of wearable camera 10 to engage with a mounted tool which is attached on the front portion of the uniform.

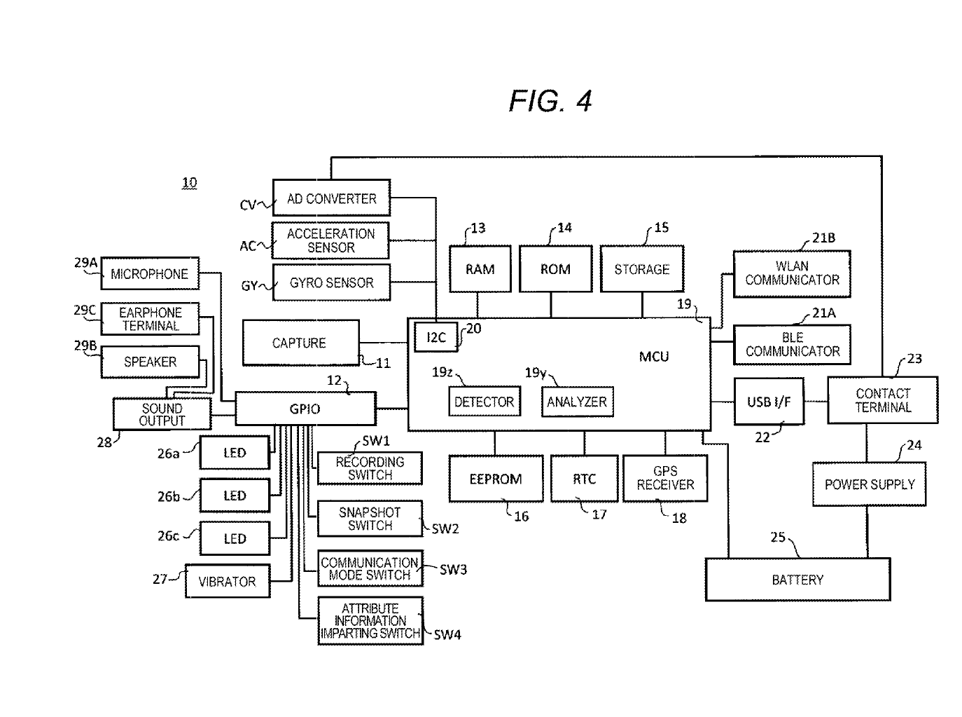

FIG. 3 is a front view illustrating an example of a front-side surface of housing 10z of wearable camera 10 of the exemplary embodiment. Recording switch SW1, snapshot switch SW2, and imaging lens 11z are disposed on the surface of the front side of housing 10z. A short press of recording switch SW1 instructs that the recording is started, and a long press (for example, an operation in which pressing state is continued for three seconds) of recording switch SW1 instructs that the recording is stopped. Snapshot switch SW2 instructs that a still image captured by capture 11 is recorded whenever being pressed. Imaging lens 11z forms an optical image of a subject to be captured by wearable camera 10 on an imaging area of capture 11 (refer to FIG. 4).

Communication mode switch SW3 and attribute information imparting switch SW4 are disposed on the side surface of housing 10z. Three LEDs 26a, 26b, and 26c are disposed on the upper surface of housing 10z. LED 26a displays a state of turning on or off of power of wearable camera 10 and a state of battery 25 (refer to FIG. 4). LED 26b displays a state of an imaging operation of wearable camera 10. LED 26c displays a state of a communication mode of wearable camera 10.

FIG. 4 is a block diagram illustrating an example of an internal configuration of wearable camera 10 of the exemplary embodiment. Wearable camera 10 is provided with capture 11, general purpose input/output 12 (GPIO), random access memory (RAM) 13, read only memory (ROM) 14, and storage 15. Wearable camera 10 is provided with electrically erasable programmable rom (EEPROM) 16, real time clock (RTC) 17, and global positioning system (GPS) receptor 18. Wearable camera 10 is provided with micro controller unit (MCU) 19, communicator 21, universal serial bus (USB) interface (I/F) 22, Contact terminal 23, power supply 24, and battery 25.

Wearable camera 10 is provided with recording switch SW1, snapshot switch SW2, communication mode switch SW3, and attribute information imparting switch SW4.

Wearable camera 10 is provided with three light emitting diodes (LED) 26a, 26b, and 26c, and vibrator 27. LEDs 26a, 26b, and 26c, and vibrator 27 function as an example of a notifier that notifies of the user.

Capture 11 includes imaging lens 11z (refer to FIG. 3), and a solid-state image sensing element formed of a charge coupled device (CCD) type image sensor or a complementary metal oxide semiconductor (CMOS) type image sensor. Capture 11 outputs the captured image data of the subject to MCU 19.

A detection terminal CON.DET of contact terminal 23 is, as described below, a terminal in which a voltage is changed in a case where wearable camera 10 is mounted (set) on multi-charging stand 89, or is detached from multi-charging stand 89. The detection terminal CON.DET of contact terminal 23 is connected to AD converter CV. A signal indicating the voltage change of the detection terminal CON.DET is converted into a digital signal in AD converter CV, and then the digital signal is input to MCU 19 via I2C 20.

GPIO 12 is a parallel interface. Recording switch SW1, snapshot switch SW2, communication mode switch SW3, attribute information imparting switch SW4, LEDs 26a, 26b, and 26c, vibrator 27, sound output 28, earphone terminal 29C, speaker 29B, and microphone 29A are connected to GPIO 12. GPIO 12 inputs and outputs signals between the aforementioned various electronic components and MCU 19. Microphone 29A, as a sound collector, collects ambient sounds of wearable camera 10, and outputs the collected sound data to MCU 19 via GPIO 12. Microphone 29A may be a built-in microphone which is accommodated in housing 10z of wearable camera 10, or may be a wireless microphone which is wirelessly connected to wearable camera 10. In a case of the wireless microphone, the police officers can attach the wireless microphone to any position of their body, and thus it is possible to enhance the sound collection. Sound output 28 outputs a sound signal relating to the operation of wearable camera 10 in response to the input operation by police officer 3 under the instruction of MCU 19. Sound output 28 reads sound data stored in ROM 14 or the like in advance or synthesizes sound data to output a sound signal for sounding a predetermined sound. Earphone terminal 29C outputs the sound signal output from sound output 28. Speaker 29B inputs the sound signal outputted from sound output 28, sounds, and outputs sound.

Gyro sensor GY, acceleration sensor AC, and AD converter CV are connected to MCU 19 via a communication interface such as inter-integrated circuit (I2C) 20. It is possible to obtain a similar effect by connecting the detection terminal CON.DET of contact terminal 23 to GPIO 12 without going through AD converter CV.

RAM 13 is a work memory which is used to operate, for example, MCU 19. ROM 14 stores program and data in advance so as to control, for example, MCU 19.

Storage 15 as an example of a recorder is formed of a storing medium such as a memory card, and starts recording the video data captured by capture 11 based on the instruction to automatically start the recording (that is, instruction of recording start). Storage 15 constantly pre-buffers and holds the captured video data for a predetermined time, and continuously stores the video data up to a predetermined time (for example, 30 seconds) before the current time. Upon receipt of the recording start instruction, storage 15 starts recording the video data and continues to record the video data after receiving the recording stop instruction. Further, storage 15 includes setting a data file in which information for resolution enhancement is set. For example, in the case where storage 15 is formed of the memory card, storage 15 is removably inserted into the housing 10z of wearable camera 10.

EEPROM 16 stores, for example, identification information (for example, a serial number as a camera ID) for identifying wearable camera 10, and various types of setting information. RTC 17 counts and outputs information on the current time to MCU 19.

GPS receptor 18 receives satellite signals including their signal transmission time and position coordinates which are transmitted from a plurality of GPS transmitters (for example, four navigation satellites) and outputs the satellite signals to MCU 19. MCU 19 calculates the current position coordinates of wearable camera 10 and the reception time of the satellite signal by using the plurality of satellite signals. Note that, such a calculation may be performed by GPS receptor 18 instead of MCU 19. The received time information is also used to correct a system time of wearable camera 10. The system time is used to record a capturing time of the captured image (including a still image and a video).

MCU 19 serves as a controller of wearable camera 10, for example, and performs a control process of controlling the entire operations of the respective portions of wearable camera 10, a data input and output process between the respective portions of wearable camera 10, a data computing (calculating) process, and a data storing process. MCU 19 is operated in accordance with the program and data stored in ROM 14. MCU 19 acquires the information on the current time from RTC 17 by using RAM 13 during the operation, and acquires information on the current position from GPS receptor 18.

MCU 19 includes detector 19z which can be realized by execution of an application program, and generates sound data which is obtained by cutting out the section of sound among items of sound data collected by microphone 29A by using detector 19z. In addition, detector 19z detects the instruction by sound signals from DTMF signals to be described below in the sound data of analog sounds collected by microphone 29A. MCU 19 executes the operation of wearable camera 10 corresponding to the instruction acquired by detector 19z.

Bluetooth low energy (BLE) communicator 21A as an example of a communicator communicates with smart phone 80 or the like by using a communication form of BLE which is a communication standard of near field communication. BLE is the name of version 4.0 of Bluetooth (trade mark). Although BLE is communicable with low power consumption, the communication speed thereof is as low as 100 kbps.

When smart phone 80 operates as an access point using a tethering function, WLAN communicator 21B is connected to smart phone 80 or wireless LAN access point 63P which is available wireless LAN in police office 4 via wireless LAN (that is, WLAN), and performs wireless communication with the connection destination. Wireless LAN can communicate at a high communication speed of tens to hundreds of Mbps as compared with BLE, but since it is constantly connected to wireless LAN access point, power consumption is increased.

In addition to the BLE communication and the WLAN communication, wearable camera 10 may include a configuration of a communicator (not shown) for performing the wireless communication through short-range wireless communication such as near field communication (NFC) or a mobile network (for example, long term evolution (LTE)). Further, the configuration of the communicator for perform the wireless communication through WLAN communicator 21B or the aforementioned mobile network functions as a receptor for receiving the instruction from command system 90.

USB interface 22 is a serial bus, and enables the connection between on-vehicle camera system 30 and back end client 70 and the like in the police office.

Contact terminal 23 which is a terminal for electrically connecting to a cradle (not shown) or an external adapter (not shown) is connected to MCU 19 via USB interface 22, and is connected to power supply 24. Battery 25 is charged via contact terminal 23, and contact terminal 23 enables the communication of the image data or the like.

Contact terminal 23 is provided with “charging terminal V+”, “CON.DET terminal”, “data terminals D− and D+” and “ground terminal” (which are not shown). The CON.DET terminal is a terminal for detecting voltage and change of the voltage. Data terminals D− and D+ are terminals for transferring the images captured by wearable camera 10 to an external PC or the like via a USB connector terminal, for example. The CON.DET terminal which is a detection terminal of contact terminal 23 is connected to a communication interface such as I2C 20 via AD converter CV, and a detected voltage value of contact terminal 23 is input to MCU 19.

When contact terminal 23 is connected to a connector such as the cradle (not shown) or the external adapter (not shown), the data communication can be performed between wearable camera 10 and external device.

Power supply 24 supplies electric power supply supplied from the cradle or the external adapter to battery 25 via contact terminal 23 so as to charge battery 25. Battery 25 is formed of, for example, a chargeable secondary battery, and supplies electric power supply to the respective portions of the wearable camera 10.

Recording switch SW1 is a pressing button switch for inputting an operation instruction to start or stop the recording (capturing video) through a pressing operation performed by police officer 3. When recording switch SW1 is pressed odd number of times, the recording (capturing video) is started, and when being pressed even number of times, the recording is finished. Further, when recording switch SW1 is pressed twice in succession, as described below, it serves as an emergency button.

Snapshot switch SW2 is a pressing button switch for inputting an operation instruction to capture a still image through a pressing operation performed by police officer 3. Whenever snapshot switch SW2 is pressed, the still image is captured at the time of being pressed.

Communication mode switch SW3 is a slide switch for inputting an operation instruction to set a communication mode between wearable camera 10 and the external device. The communication mode includes, for example, an access-point mode, a station mode, and an OFF mode.

The access-point mode is a mode in which wearable camera 10 is operated as an access point of the wireless LAN, and is wirelessly connected to smart phone 40 which is belongs to police officer 3 such that the communication is performed between wearable camera 10 and smart phone 40. In the access-point mode, smart phone 40 is connected to wearable camera 10, and thus can perform display of the current live image, playback of the recorded image, and display of the captured still image through wearable camera 10.

The station mode is a mode in which the communication is performed with an external device as an access point in a case of connecting to the external device by using the wireless LAN. For example, smart phone 40 is set as an external device by using a tethering function of smart phone 40. In the station mode, wearable camera 10 can perform, for example, various settings and transferring (uploading) of the recorded images kept by wearable camera 10 with respect to on-vehicle camera system 30 or back end client 70 or back end server 50 in police office 4.

The OFF mode is a mode in which a communicating operation of the wireless LAN is off, and the wireless LAN is set to be in an unused state.

Attribute information imparting switch SW4 is a pressing button switch for imparting attribute information to the video data.

LED 26a is a display which displays a power-on state of wearable camera 10 (a state of being turned on and off) and a state of battery 25. LED 26b is a display which displays a state of an imaging operation of wearable camera 10 (a recording state). LED 26c is a display which displays a state of a communication mode of wearable camera 10. In addition, when wearable camera 10 receives notification data from back end server 50, three LEDs 26a to 26c perform a flashing operation in accordance with the instruction from MCU 19. At this time, MCU 19 changes flashing patterns of LEDs 26a to 26c in accordance with the information on the sound sources included in the notification data.

Gyro sensor GY as an example of the sensor, wearable camera 10 detects an angular velocity (that is, rotation angle per unit time) of wearable camera 10 and detects that police officer 3 who has wearable camera 10 mounted on the uniform or carries wearable camera 10 is fell down (Man Down), for example. The detection result of gyro sensor GY is input to MCU 19 via I2C 20. Wearable camera 10 can accurately detect the action of police officer 3 who has wearable camera 10 mounted on the uniform or carries wearable camera 10, such as rotations (for example, fell down on the ground, fell down on the ground by being shot by the pistol, and fell down on the ground by being attacked by a deadly weapon) by using gyro sensor GY.

Acceleration sensor AC as an example of the sensor detects acceleration of the Cartesian coordinate system of wearable camera 10 in the three-axis direction (that is, x-axis, y-axis, and z-axis), and detects, for example, that police officer 3 who has wearable camera 10 mounted on the uniform or carries wearable camera 10 is fell down (Man Down), starts to run, and takes a shooting position with his or her own pistol. The detection results of acceleration sensor AC are input to MCU 19 via I2C 20. Wearable camera 10 can accurately detect the action relating to the movement or posture of police officer 3 who has wearable camera 10 mounted on the uniform or carries wearable camera 10 by using acceleration sensor AC.

MCU 19 performs the input and detection of each of recording switch SW1, snapshot switch SW2, communication mode switch SW3, and attribute information imparting switch SW4, and performs processing with respect to the operated switch input.

In a case where the operated input of recording switch SW1 is detected, MCU 19 controls the start or the stop of the imaging operation in capture 11, and stores the image obtained from capture 11 as a video in storage 15.

In a case where the operated input of snapshot switch SW2 is detected, MCU 19 stores the image captured by capture 11 when snapshot switch SW2 is operated as a still image in storage 15.

MCU 19 detects the state of communication mode switch SW3, and operates communicator 21 by the communication mode in accordance with the setting of communication mode switch SW3.

In a case where attribute information imparting switch SW4 is pressed, MCU 19 imparts the attribute information to the cut-out data including the face image which is cut out from the image captured by capture 11.

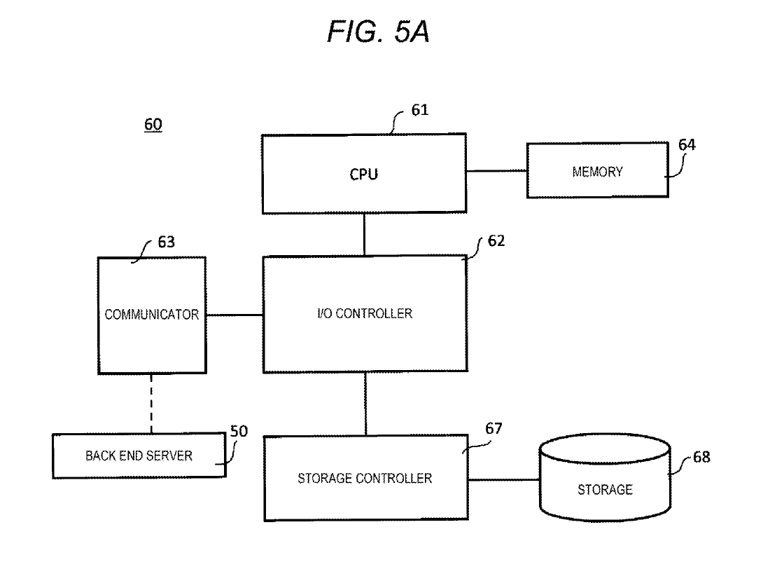

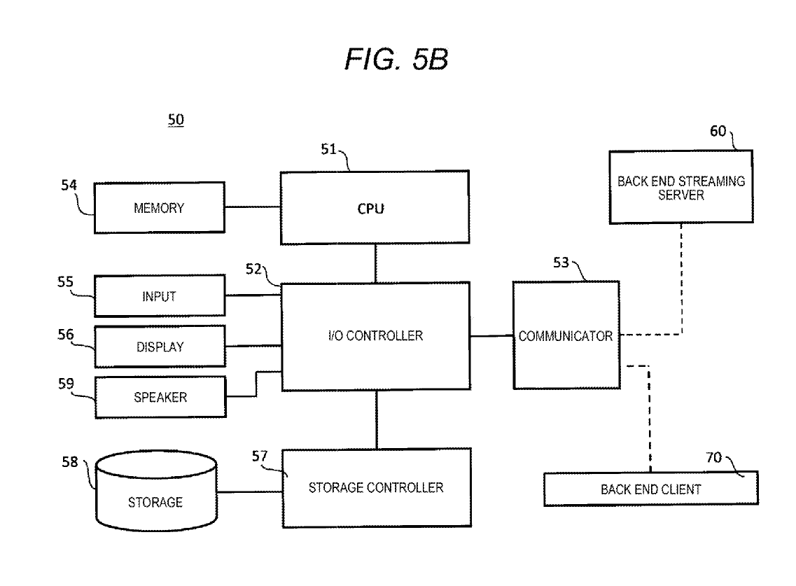

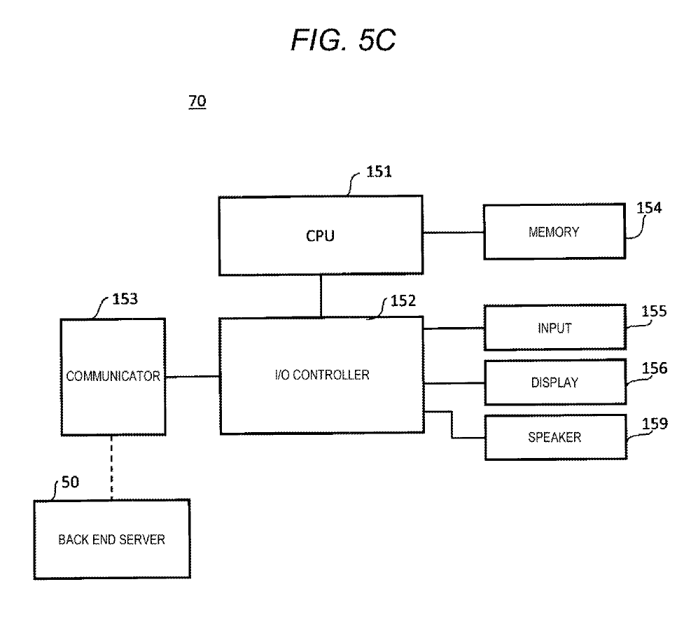

FIG. 5A is a block diagram specifically illustrating an example of an internal configuration of back end streaming server 60 of the exemplary embodiment. Back end streaming server 60 as an example of the server receives and stores the captured video data transmitted from wearable camera 10, and transmits the captured video data to back end server 50. Back end streaming server 60 is provided with CPU 61, I/O controller 62, communicator 63, memory 64, storage controller 67, and storage 68. Note that, back end streaming server 60 is a PC performing data transmission in response to the request from back end server 50, and thus it is not indispensable to provide an input such as a mouse or a display such as a display screen, but it may be provided.

CPU 61 performs a control process of controlling the entire operations of the respective portions of back end streaming server 60, a data input and output process between the respective portions, and a data storing process. CPU 61 is operated in accordance with the program and data stored in memory 64.

Memory 64 which is formed of, for example, RAM, ROM, and nonvolatile or volatile semiconductor memory serves as a work memory during the operation of CPU 61, and stores a predetermined program and data for operating CPU 61.

Back end server 50, storage controller 67, and communicator 63 are connected to I/O controller 62. Back end streaming server 60 transfers data to back end server 50 via I/O controller 62.

Communicator 63 is connected to wearable camera 10 via the wireless communication network between back end streaming server 60, and smart phone 40, and smart phone 40, and receives video data transmitted from wearable camera 10.

Storage controller 67 controls an operation of storage 68. Storage 68 is a storage device such as SSD and HDD which are controlled by storage controller 67, and stores video data transmitted from wearable camera 10 via I/O controller 62 in accordance with instruction of CPU 61.

FIG. 5B is a block diagram illustrating an example of a hardware configuration of back end server 50 of the exemplary embodiment. As an example of the server, back end server 50 is provided with CPU 51, I/O controller 52, communicator 53, memory 54, input 55, display 56, storage controller 57, speaker 59, and storage 58.

CPU 51 performs a control process of controlling the entire operations of the respective portions of back end server 50, a data input and output process between the respective portions, a data computing (calculating) process, and a data storing process. CPU 51 is operated in accordance with the program and data stored in memory 54.

I/O controller 52 performs control relating to the input and output of data between CPU 51 and the respective portions (for example, communicator 53, input 55, display 56, and storage controller 57) of back end server 50, and performs relay of the data from CPU 51 and data to CPU 51. Note that, I/O controller 52 may be integrally formed with CPU 51.

Communicator 53 perform wire or wireless communication with on-vehicle recorder 33, on-vehicle PC 32, smart phone 80, wearable camera 10 which is mounted on or belongs to the uniform of police officer 3, or back end client 70.

Memory 54 which is formed of, for example, RAM, ROM, and nonvolatile or volatile semiconductor memory serves as a work memory during the operation of CPU 51, and stores a predetermined program and data so as to operate CPU 51.

Input 55 is a user interface (UI) which receives an input operation of police officer 3 or a person in charge in police office 4, and notifies CPU 51 of the input operation via I/O controller 52, and is a pointing device such as a mouse and keyboard. Input 55 which is correspondingly disposed on the screen of display 56 may be formed of a touch panel or a touch pad which can be operated by a finger of police officer 3 or the person in charge or a stylus pen. In addition, back end server 50 can be operated from back end client 70 connected to the network in police office 4.

Display 56 is formed by using, for example, LCD and organic EL, and displays various types of information. Display 56 displays this video on the screen under the instruction of CPU 51 in a case where the video which is captured or recorded by wearable camera 10 is input in accordance with the input operation by police officer 3 or the person in charge, for example. Display 56 displays this video on the screen under the instruction of CPU 51 in a case where the video which is captured or recorded by on-vehicle camera 31 is input in accordance with the input operation by police officer 3 or the person in charge, for example. In addition, in the case of being operated from back end client 70 connected to the network in police office 4, the various pieces of information are displayed on back end client 70.

Speaker 59 outputs the sound under the instruction of CPU 51 in a case where the sound collected by wearable camera 10 is input in accordance with the input operation by police officer 3 or the person in charge, for example. In addition, in the case of being operated by back end client 70 connected to the network in police office 4, the sound is output to the speaker connected to back end client 70.

In a case where CPU 51 requests back end streaming server 60 to transmit the stored captured video data, in response to the request, storage controller 57 controls an operation of storing video data received to storage 58. Storage 58 is a storage device such as SSD and HDD which are controlled by storage controller 57, and stores video data transmitted from wearable camera 10 via I/O controller 52 in accordance with instruction of CPU 51.

FIG. 5C is a block diagram illustrating an example of a hardware configuration of back end client 70 of the exemplary embodiment. Back end client 70 is provide with CPU 151, I/O controller 152, communicator 153, memory 154, input 155, display 156, and speaker 159.

CPU 151 performs a control process of controlling the entire operations of the respective portions of back end client 70, a data input and output process between the respective portions, a data computing (calculating) process, and a data storing process. CPU 151 is operated in accordance with the program and data stored in memory 154.

I/O controller 152 performs control relating to the input and output of data between CPU 151 and the respective portions (for example, communicator 153, input 155, and display 156) of back end client 70, and performs relay of the data from CPU 151 and data to CPU 151. Note that, I/O controller 152 may be integrally formed with CPU 151.

Communicator 153 performs the wire communication between wearable cameras 10 connected to wire LAN in police office 4. In addition, communicator 153 may perform wire or wireless communication with on-vehicle recorder 33, on-vehicle PC 32, smart phone 80, wearable camera 10 which is mounted on or belongs to the uniform of police officer 3, and back end server 50.

Memory 154 which is formed of, for example, RAM, ROM, and nonvolatile or volatile semiconductor memory serves as a work memory during the operation of CPU 151, and stores a predetermined program and data so as to operate CPU 151.

Input 155 is a user interface (UI) which receives an input operation of police officer 3 or a person in charge in police office 4, and notifies CPU 151 of the input operation via I/O controller 152, and is a pointing device such as a mouse and keyboard. Input 155 which is correspondingly disposed on the screen of display 156 may be formed of a touch panel or a touch pad which can be operated by a finger of police officer 3 or the person in charge or a stylus pen.

Display 156 is formed by using, for example, LCD and organic EL, and displays various types of information. Display 156 displays this video on the screen under the instruction of CPU 151 in a case where the video which is captured or recorded by wearable camera 10 is input in accordance with the input operation by police officer 3 or the person in charge, for example. Display 156 displays this video on the screen under the instruction of CPU 151 in a case where the video which is captured or recorded by on-vehicle camera 31 is input in accordance with the input operation by police officer 3 or the person in charge, for example.

Speaker 159 outputs the sound under the instruction of CPU 151 in a case where the sound collected by wearable camera 10 is input in accordance with the input operation by police officer 3 or the person in charge, for example.

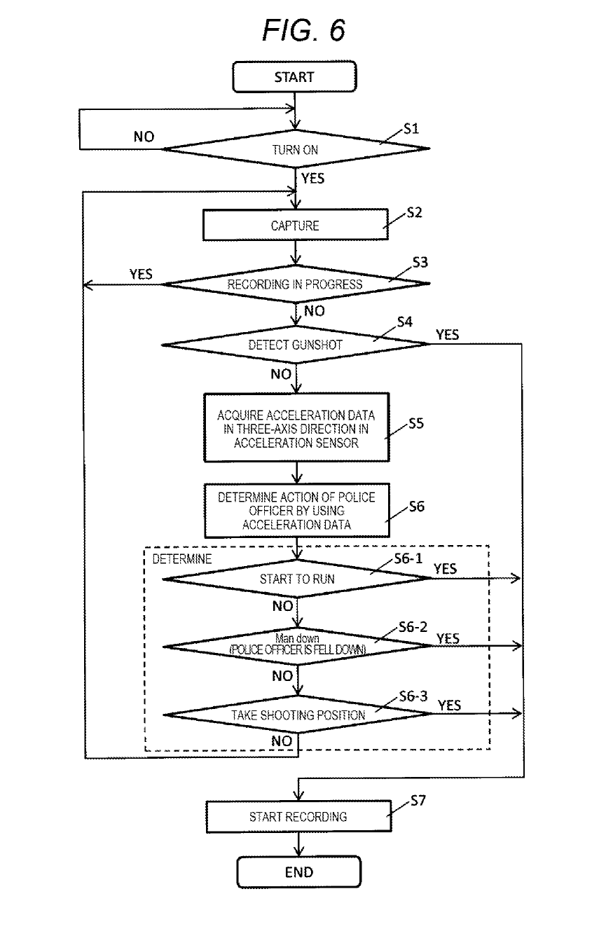

Next, the starting procedure of the automatic recording in wearable camera 10 of the exemplary embodiment will be described with reference to the FIG. 6. FIG. 6 is a flowchart specifically illustrating an example of operation procedure of automatic recording in wearable camera 10 of the exemplary embodiment.

In FIG. 6, wearable camera 10 waits until the power is turned on (NO in S1). For example, when the power of wearable camera 10 is turned on by the operation of police officer 3 (S1, YES), wearable camera 10 starts capturing the front side of police officer 3 as a subject by capture 11 (S2). If wearable camera 10 is in the middle of recording (that is, while the captured video data captured in Step S2 is stored in storage 15) (S3, YES), the processing of wearable camera 10 returns to Step S2.

If wearable camera 10 is not in the middle of recording (that is, while the captured video data captured in Step S2 is stored in storage 15) (NO in S3), wearable camera 10 determines whether or not the gunshot of the pistol is detected (S4). A method of detecting the gunshot of the pistol is well-known method, for example, detector 19z of MCU 19 determines whether or not a frequency feature of sounds collected by microphone 29A of wearable camera 10 and a frequency feature of the gunshot of the pistol which is registered in storage 15 in advance are matched with each other.

In a case where it is determined that the gunshot of the pistol is detected (YES in S4), wearable camera 10 stores (that is, records) captured video data captured in Step S2 in storage 15 (S7). With this, wearable camera 10 can start automatic recording as soon as it detects the gunshot of the pistol (for example, pistol of police officer 3 who wears or holds wearable camera 10), and thus it is possible to leave videos of the atmosphere of the tense site where the gunshot of the pistol is detected as evidence videos.

Wearable camera 10 may record captured video data in the same way even in a case where the gunshot at the time of shooting the pistol possessed by a person (for example, a suspect on escape related to an incident) other than police officer 3 who wears or holds wearable camera 10. With this, even in a case of being shoot by a pistol held by a person other than police officer 3 who wears or holds wearable camera 10, wearable camera 10 detects the gunshot at the time of shooting, and thus can record and store the captured video data even in a case where the police officer 3 does not shoot the pistol his or herself.

On the other hand, even in a case where it is not determined that the gunshot of the pistol is detected (NO in S4), wearable camera 10 acquires acceleration data in the three-axis direction in the acceleration sensor AC (S5). Wearable camera 10 determines the action of police officer 3 who has wearable camera 10 mounted on the uniform or carries wearable camera 10 in detector 19z as an example of a determiner by using the acceleration data acquired in Step S5 (S6). The determination in Step S6 is performed depending on the presence or absence of execution of the respective processes of Steps S6-1, S6-2, and S6-3, for example.

Specifically, wearable camera 10 detects whether or not police officer 3 has run (S6-1). In other words, wearable camera 10 holds first known data which indicates statistical changes in acceleration data when a person suddenly starts running in storage 15, and determines whether or not the acceleration data acquired in Step S5 matches this first known data (for example, whether or not the difference value between the acceleration data and the first known data is within a first predetermined value, the same will applies hereinafter) in the detector 19z. In a case where the acceleration data matches with the first known data, wearable camera 10 determines that police officer 3 suddenly starts running from the state of being stop (YES in S6-1), and stores (that is, records) captured video data captured in Step S2 in storage 15 (S7). With this, wearable camera 10 can start automatic recording when, for example, starting to chase or to be chased by the suspect on escape related to the incident, and thus it is possible to leave videos of the atmosphere of the tense site where the police officer encounters the suspect is detected as evidence videos.

On the other hand, in a case where police officer 3 has not run (NO in S6-1), wearable camera 10 detects whether or not police officer 3 is fell down (S6-2). In other words, wearable camera 10 holds a second known data which indicates statistical changes in acceleration data when a person is fell down in storage 15, and determines whether or not the acceleration data acquired in Step S5 matches this second known data (for example, whether or not the difference value between the acceleration data and the second known data is within a second predetermined value, the same will applies hereinafter) in detector 19z. In a case where the acceleration data matches with the second known data, wearable camera 10 determines that police officer 3 is fell down (YES in S6-2), and stores (that is, records) captured video data captured in Step S2 in storage 15 (S7). With this, wearable camera 10 can start automatic recording when the police officer is beaten by a suspect on escape related to the incident and fell down, and thus it is possible to leave videos of the atmosphere of the tense site where the consciousness of the police officer 3 is far away as evidence videos.

On the other hand, in a case where police officer 3 is not fell down (NO in S6-2), wearable camera 10 detects whether or not police officer 3 has taken a shooting position with his or her own pistol (S6-3). In other words, wearable camera 10 holds a third known data which indicates statistical changes in acceleration data when police officer has taken a shooting position with his or her own pistol in storage 15, and determines whether or not the acceleration data acquired in Step S5 matches this third known data (for example, whether or not the difference value between the acceleration data and the third known data is within a third predetermined value, the same will applies hereinafter) in detector 19z. In a case where the acceleration data matches with the third known data, wearable camera 10 determines that police officer 3 has taken a shooting position with his or her own pistol (YES in S6-3), and stores (that is, records) captured video data captured in Step S2 in storage 15 (S7). With this, wearable camera 10 can start automatic recording when the police officer chases down the suspect on escape related to the incident and has taken a shooting position with his or her own pistol with respect to the suspect, and thus it is possible to leave videos of the atmosphere of the tense site where the police officer chases the suspect as evidence videos.

On the other hand, in a case where police officer 3 does not take a shooting position with his or her own pistol (NO in S6-3), the process of wearable camera 10 returns to Step S2.

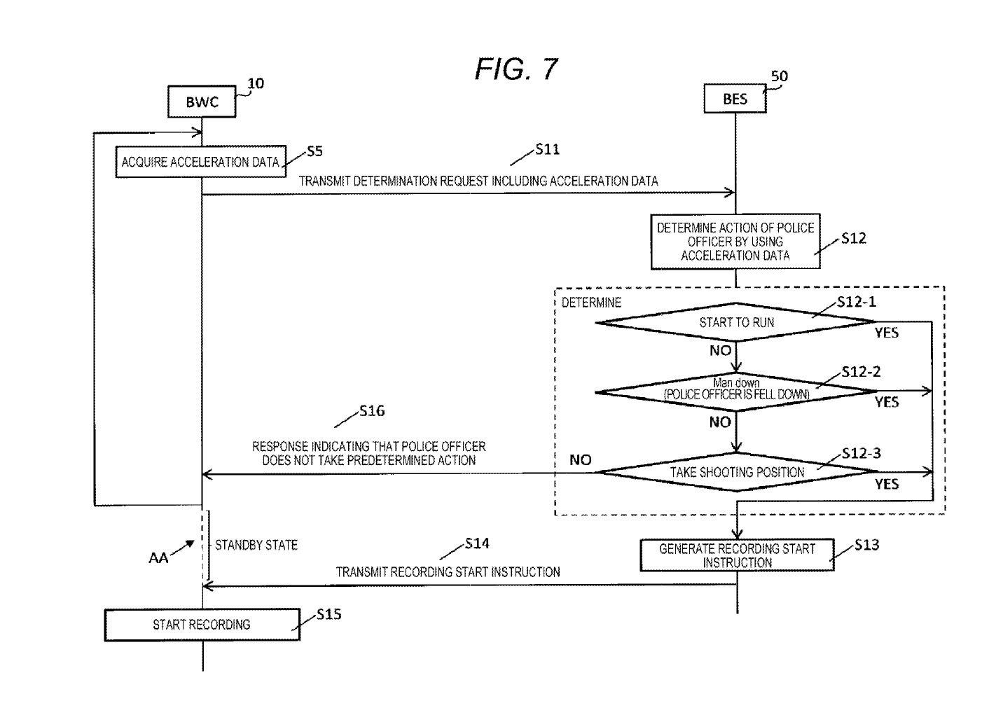

Next, the starting procedure of the automatic recording performed by wearable camera 10 based on association of wearable camera 10 of the exemplary embodiment with back end server 50 will be described with reference to FIG. 7. FIG. 7 is a sequence diagram specifically illustrating an example of operation procedure of automatic recording in wearable camera system 5 of the exemplary embodiment. In FIG. 7, wearable camera 10 is denoted as BWC, and back end server 50 is denoted as BES. In the illustration of FIG. 7, wearable camera 10 and back end server 50 may wirelessly communicate with each other, for example, wearable camera 10 and back end server 50 may wirelessly communicate with each other in a direct manner, or wearable camera 10 and back end server 50 may wirelessly communicate with each other via smart phone 40.

In FIG. 7, wearable camera 10 performs processes of Step S1 to Step S4 as illustrated in FIG. 6, and after Step S4, performs a process of Step S5 (that is, acceleration data of the three-axis direction in the acceleration sensor AC is acquired) (S5). Each time wearable camera 10 acquires the acceleration data in step S5, wearable camera 10 generates a determination request including the acquired acceleration data and repeatedly transmits the determination request to back end server 50 periodically (for example, every 100 msec) (S11). This determination request requests back end server 50 to determine whether or not police officer 3 has performed a predetermined action (specifically, any one of an action of Step S12-1 corresponding to Step S6-1, an action of Step S12-2 corresponding to Step S6-2, and an action of Step S12-3 corresponding to Step S6-3) using the acceleration data acquired by wearable camera 10.

When back end server 50 receives the determination request transmitted in Step S11 several times (that is, for as many times as it can obtain a plurality of items of acceleration data), it determines the action of that police officer 3 who has wearable camera 10 mounted on the uniform or carries wearable camera 10 (S12). The determination in Step S12 is performed depending on the presence or absence of execution of the respective processes of Steps S12-1, S12-2, and S12-3, for example.

Specifically, back end server 50 detects whether or not police officer 3 has run (S12-1). That is, back end server 50 holds first known data which indicates statistical changes in acceleration data when a person suddenly starts running in storage 58, and determines whether or not the received acceleration data matches this first known data (for example, whether or not the difference value between the acceleration data and the first known data is within the first predetermined value, the same will applies hereinafter). In a case where acceleration data matches with the first known data, back end server 50 determines that police officer 3 suddenly starts running from the state of being stop (YES in S12-1), and generates a recording start instruction of the captured video data (S13). Back end server 50 transmits the recording start instruction to wearable camera 10 (S14). When receiving the recording start instruction transmitted from back end server 50, wearable camera 10 starts recording of the captured video data captured in Step S2 (S15). With this, wearable camera 10 can start automatic recording when back end server 50 correctly determines that the police officer starts to chase or to be chased by the suspect on escape related to the incident as compared with the determination of wearable camera 10, and thus it is possible to leave videos of the atmosphere of the tense site where the police officer encounters the suspect is detected as evidence videos. In addition, wearable camera 10 can more accurately determine that the police officer 3 has started running in the back end server 50, and thus it is possible to record the video having necessary capacity when necessary.

On the other hand, in a case where police officer 3 starts to run (NO in S12-1), back end server 50 detects whether or not police officer 3 is fell down (S12-2). In other words, back end server 10 holds a second known data which indicates statistical changes in acceleration data when a person is fell down in storage 58, and determines whether or not the acquired acceleration data matches this second known data (for example, whether or not the difference value between the acceleration data and the second known data is within a second predetermined value, the same will applies hereinafter). In a case where the acceleration data matches with the second known data, back end server 50 determines that police officer 3 is fell down (YES in S12-2), and generates the recording start instruction of the captured video data (S13). Back end server 50 transmits the recording start instruction to wearable camera 10 (S14). When receiving the recording start instruction transmitted from back end server 50, wearable camera 10 starts recording of the captured video data captured in Step S2 (S15). With this, wearable camera 10 can start automatic recording when back end server 50 correctly determines that the police officer is beaten by a suspect on escape related to the incident and fell down as compared with the determination of wearable camera 10, and thus it is possible to leave videos of the atmosphere of the tense site where the consciousness of the police officer 3 is far away as evidence videos. In addition, wearable camera 10 can more accurately determine that the police officer 3 has started running in the back end server 50, and thus it is possible to record the video having necessary capacity when necessary.

On the other hand, in a case where police officer 3 is not fell down (NO in S12-2), back end server 50 detects whether or not police officer 3 has taken a shooting position with his or her own pistol (S12-3). In other words, back end server 50 holds a third known data which indicates statistical changes in acceleration data when police officer has taken a shooting position with his or her own pistol in storage 58, and determines whether or not the acquired acceleration data matches this third known data (for example, whether or not the difference value between the acceleration data and the third known data is within a third predetermined value, the same will applies hereinafter). In a case where the acceleration data matches with the third known data, back end server 50 determines that police officer 3 has taken a shooting position with his or her own pistol (YES in S12-3), and generates of the recording start instruction the captured video data (S13). Back end server 50 transmits the recording start instruction to wearable camera 10 (S14). When receiving the recording start instruction transmitted from back end server 50, wearable camera 10 starts recording the captured video data captured in Step S2 (S15). With this, wearable camera 10 can start automatic recording when back end server 50 correctly determines that the police officer chases down the suspect on escape related to the incident and has taken a shooting position with his or her own pistol with respect to the suspect as compared with the determination of wearable camera 10, and thus it is possible to leave videos of the atmosphere of the tense site where the police officer chases the suspect as evidence videos. In addition, wearable camera 10 can more accurately determine that police officer 3 has taken a shooting position with his or her own pistol in the back end server 50, and thus it is possible to record the video having necessary capacity when necessary.

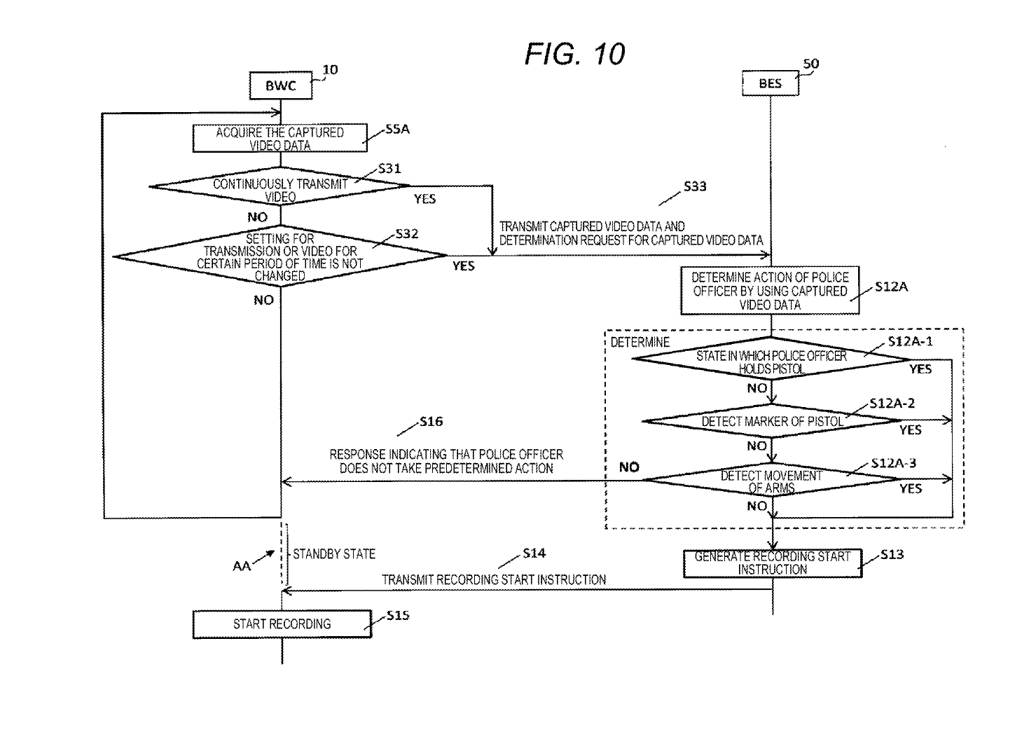

On the other hand, in a case where police officer 3 does not take a shooting position with his or her own pistol (NO in S12-3), back end server 50 transmits a response indicating that the police officer does not take a predetermined action as described above to wearable camera 10 (S16). After the response transmitted in Step S16 is received in wearable camera 10, the process of wearable camera 10 returns to Step S2 (refer to FIG. 6) or Step S5. Note that, even when the response of Step S16 is returned to wearable camera 10, in a case where wearable camera 10 detects the gunshot of the pistol, wearable camera 10 may start recording the captured video data captured in Step S2 as illustrated in FIG. 6. In addition, with respect to the operation of wearable camera 10 in FIG. 7, a dotted line portion AA is in a standby state without particular processing of wearable camera 10, and the same is true for a dotted line portion AA shown in FIG. 10 to be described below.

As described above, wearable camera 10 of the exemplary embodiment which is mounted on or belongs to police officer 3 as an example of a user captures a subject (for example, a scene of the incident site) on the front side of police officer 3, and acquires information (for example, acceleration data) on the movement of police officer 3. Based on the acquired information on the movement of police officer 3, wearable camera 10 determines whether or not a predetermined action (the above-described predetermined action) is performed by the police officer, and in a case where it is determined that the predetermined action is performed, recording of captured video data is started in MCU 19 as an example of a recording controller.

With this, in such a tense situation where police officer 3 chases the suspect on escape related to the incident, even if police officer 3 does not operate the manual start of the recording start in person, wearable camera 10 can reduce the missing of the recording by starting the recording of the video captured by wearable camera 10. Accordingly, wearable camera 10 can efficiently assist police officer 3 with their services.

In addition, wearable camera 10 determines whether or not police officer 3 starts to run as a predetermined action. With this, wearable camera 10 can start automatic recording when, for example, starting to chase or to be chased by the suspect on escape related to the incident, and thus it is possible to leave videos of the atmosphere of the tense site where the police officer encounters the suspect is detected as evidence videos.

Wearable camera 10 determines whether or not as a predetermined action, police officer 3 has taken a shooting position with a pistol belonging to police officer 3. With this, wearable camera 10 can start automatic recording when the police officer chases down the suspect on escape related to the incident and has taken a shooting position with his or her own pistol with respect to the suspect, and thus it is possible to leave videos of the atmosphere of the tense site where the police officer chases the suspicious person as evidence videos.

Wearable camera 10 determines whether or not as a predetermined action, police officer 3 is fell down on the ground or the like. With this, wearable camera 10 can start automatic recording when the police officer is beaten by a suspect on escape related to the incident and fell down, and thus it is possible to leave videos of the atmosphere of the tense site where the consciousness of the police officer 3 is far away as evidence videos.

Wearable camera 10 includes microphone 29A which collects sounds, and determines whether or not the sound collected microphone 29A is the gunshot of the pistol. With this, wearable camera 10 start automatically recording as soon as it detects the gunshot of the pistol (for example, the pistol belonging to police officer 3 who has wearable camera 10 mounted on the uniform or carries wearable camera 10), and thus it is possible to leave videos of the atmosphere of the tense site where the gunshot of the pistol is detected as evidence videos.

Wearable camera system 5 of the exemplary embodiment is configured such that wearable camera 10 which is mounted on or belongs to police officer 3 and back end server 50 are communicably connected to each other. Wearable camera 10 captures a subject (for example, a scene of the incident site) on the front side of police officer 3, and acquires information (for example, acceleration data) on the movement of police officer 3. Wearable camera 10 transmits the determination request including information on the acquired movement of police officer 3 to back end server 50. When receiving the determination request, back end server 50 determines whether or not a predetermined action (the above-described predetermined action) is performed by police officer 3 based on the information on the movement of police officer 3 included in the determination request. In a case where it is determined that a predetermined action is performed, back end server 50 generates a recording start instruction for instructing recording start of captured video data, and transmits the recording start instruction to wearable camera 10. When receiving recording start instruction transmitted from back end server 50, wearable camera 10 starts the recording of the captured video data in response to the received recording start instruction.

With this, in wearable camera system 5, in such a tense situation where police officer 3 chases the suspect on escape related to the incident, it is possible to determine whether or not police officer 3 takes a predetermined action in back end server 50 with high accuracy as compared with the case where wearable camera 10 independently determines the start of the recording even if police officer 3 does not operate the manual start of the recording start in person. Therefore, the wearable camera 10 can start recording of the captured video data based on highly accurate detection of the predetermined action of police officer 3, and it is possible to reduce the missing of the video recording for the important incident site. Accordingly, wearable camera 10 can efficiently assist police officer 3 with their services.

### Modification Example of First Embodiment

In the above-described embodiments, wearable camera 10 starts the automatic recording of the captured video data. In a case where wearable camera 10 detects gunshot or wearable camera 10 or back end server 50 determines that the predetermined action is performed based on the acceleration data.

In the modification example of the above-described embodiments (hereinafter referred to as “modification example”), wearable camera 10 determines whether or not police officer 3 has taken a predetermined action through the video analysis, and in a case where it is determined that police officer 3 has taken a predetermined action through the video analysis, and wearable camera 10 starts the automatic recording of the captured video data.

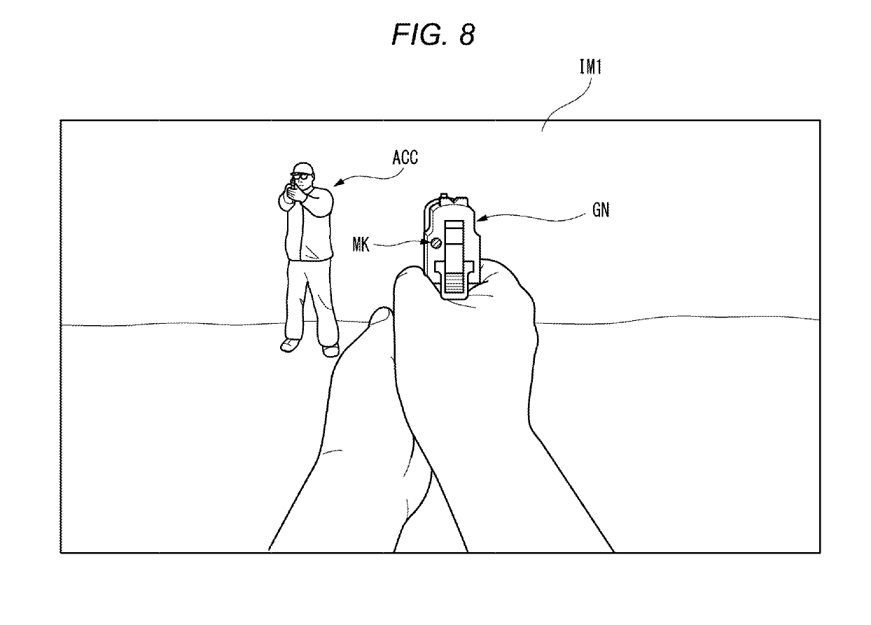

FIG. 8 is a diagram illustrating an example of captured image IM1 in a state where police officer 3 holds his or her pistol GN. In the modification example, it is assumed that marker MK is given in advance to pistol GN used by police officer 3. In captured image IM1 in FIG. 8, for example, a situation in which suspect ACC with pistol on escape who related to the incident is threatening towards police officer 3. In the modification example, as illustrated in captured image IM1 of FIG. 8, wearable camera 10 starts the recording of the captured video data even in a case where various situations of having pistol GN through the video analysis of captured image IM1 can be detected.

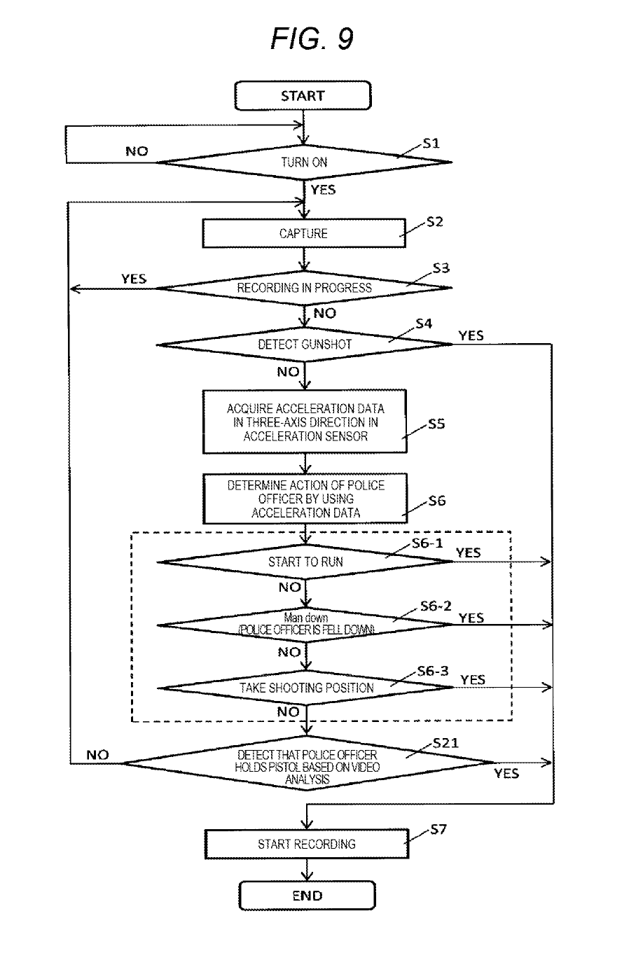

FIG. 9 is a flowchart specifically illustrating an example of operation procedure of automatic recording in a wearable camera 10 of the modification example. In the illustration of FIG. 9, the same step numbers are given to the same processes as those in FIG. 6, the explanation will be simplified or not be repeated, and different contents will be described.

In FIG. 9, police officer 3 does not take a shooting position with his or her own pistol GN (NO in S6-3), wearable camera 10 analyzes the captured video data captured in Step S2 in analyzer 19y (S21). Analyzer 19y detects the presence or existence of a predetermined action of police officer 3 (for example, holding his or her own pistol GN) by performing a known analysis process on the captured video captured by capture 11.

In a case where it is determined that police officer 3 has taken a predetermined action (for example, holding his or her own pistol GN) in analyzer 19y (YES in S21), wearable camera 10 stores (that is, records) the captured video data captured in Step S2 in storage 15 (S7).

With this, when it is determined that police officer 3 holds a pistol (that is, when the police officer holds pistol GN on the suspect on escape related to the incident) based on the analysis of the captured video, wearable camera 10 can start automatic recording, and thus it is possible to leave videos of the atmosphere of the tense site where the police officer confronts with the suspect as evidence videos.

On the other hand, in a case where it is determined that police officer 3 does not take a predetermined action (for example, holding his or her own pistol GN) in analyzer 19y (NO in S21), the process of wearable camera 10 returns to Step S2.

In this regard, wearable camera 10 can determine that police officer 3 takes a predetermined action (for example, holding his or her own pistol GN) in analyzer 19y, for example, through the following three methods.

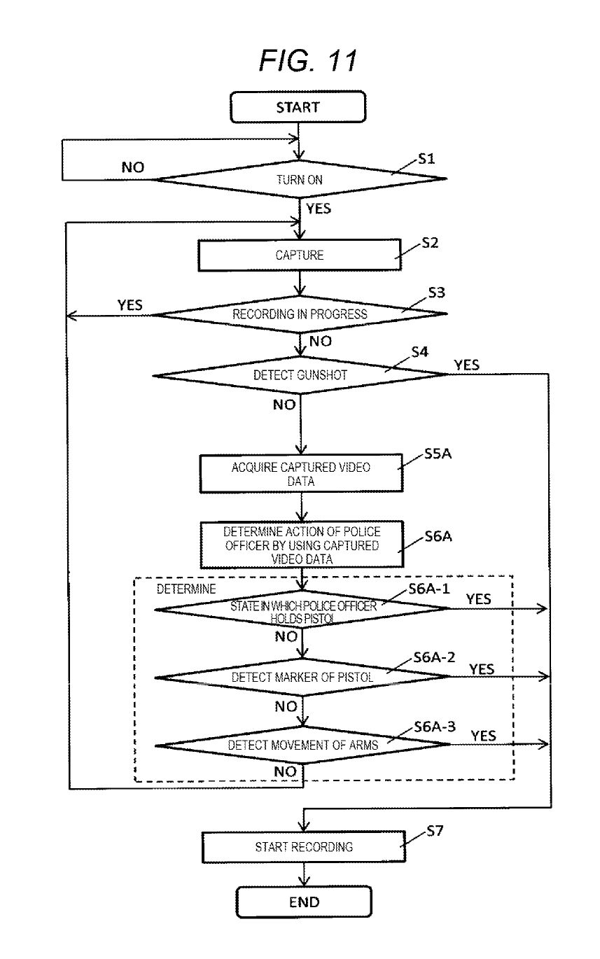

First method (refer to S6A-1 in FIG. 11): in a case where arms of police officer 3 are recognized in the captured video, (more specifically, in a case where the posture of arms for taking the shooting position and the position of pistol GN on the arm are recognized), analyzer 19y determines that police officer 3 has taken a predetermined action (for example, holding his or her own pistol GN). That is, in the first method, a pattern image the posture of arms for taking the shooting position (in other words, the posture of the arm gripping the pistol) and a pattern image of the pistol are stored in storage 15. In this case, when the pattern image of the posture of arms for taking the shooting position and the pattern image of the pistol are detected in the captured video based on the pattern recognition of a known technique with reference to the drawings storage 15, analyzer 19y determines that police officer 3 has taken a predetermined action (for example, holding his or her own pistol GN).

With this, when the pattern image of the posture of arms for taking the shooting position and the pattern image of the pistol are detected in the captured video, wearable camera 10 can start automatic recording of the captured video data, and thus it is possible to leave videos of the atmosphere of the tense site where police officer 3 holds his or her own pistol GN as evidence videos.

Second method (refer to S6A-2 in FIG. 11): in a case where marker MK given to pistol GN (that is, a specific symbol that can improve the recognition rate) is recognized in the captured video, analyzer 19y determines that police officer 3 has taken a predetermined action (for example, holding his or her own pistol GN). In other words, in the second method, a pattern image of marker MK as a specific symbol is stored in storage 15. In this case, when the pattern image of marker MK is detected in the captured video based on the pattern recognition of a known technique with reference to the drawings storage 15, analyzer 19y determines that police officer 3 has taken a predetermined action (for example, holding his or her own pistol GN).

With this, when marker MK which is likely to be recognized among videos at the time of holding pistol GN in the shooting position is detected in the captured video, wearable camera 10 can start automatic recording of the captured video data, and thus it is possible to leave videos of the atmosphere of the tense site where police officer 3 holds his or her own pistol GN as evidence videos.

Third method (refer to S6A-3 in FIG. 11): in a case where the arms of police officer 3 holding pistol GN are moved to the shooting position from the lower side of the captured video within a certain period of time in the captured video, analyzer 19y determines that police officer 3 has taken a predetermined action (for example, holding his or her own pistol GN). That is, in the third method, a pattern image of the posture of the arms for taking the shooting position (in other words, the posture of the arm gripping the pistol) and a pattern image of the pistol are stored in storage 15. In this case, when the pattern image of the posture of arms for taking the shooting position and the pattern image of the pistol are detected in the captured video based on the pattern recognition of a known technique with reference to the drawings storage 15, and the pattern image of the posture of the arms is moved from the lower side of the captured video to a predetermined position (for example, an upward direction or center position), analyzer 19y determines that police officer 3 has taken a predetermined action (for example, holding his or her own pistol GN).

With this, based on a tendency that the arms of police officer 3 tend to lift naturally or instantaneously upwards at the time of holding pistol GN in the shooting position, when behaviors of this tendency are detected, wearable camera 10 can start automatic recording of the captured video data, and thus it is possible to leave videos of the atmosphere of the tense site where police officer 3 holds his or her own pistol GN as evidence videos.

In the first to third methods described above, only a single method is used, and a plurality of methods may be appropriately combined and used. With this, the wearable camera 10 can detect that police officer 3 holds his or her own pistol GN with high accuracy through the video analysis.

The above first to third methods may be executed within the wearable camera 10, or may be executed by transmitting the captured video data to back end server 50 from wearable camera 10 such that back end server 50 performs the video analysis. In this case, back end server 50 determines the presence or absence of automatic start of recording in wearable camera 10. One example of the execution in this case is illustrated in FIG. 10. FIG. 10 is a sequence diagram specifically illustrating an example of operation procedure of automatic recording in a wearable camera system 5 of the modification example. In the illustration of FIG. 10, the same step numbers are given to the same processes as those in FIG. 7, the explanation will be simplified or not be repeated, and different contents will be described.

In FIG. 10, wearable camera 10 acquires the captured video data (S5A). Thereafter, for example, when wearable camera 10 is set to continuously transmit the captured video data to back end server 50, such as “during streaming of live video to back end server 50” (S31, YES), wearable camera 10 transmits the captured video data and a determination request for this captured video data to back end server 50 (S33).

On the other hand when being set to continuously transmit the captured video data (NO in S31), wearable camera 10 determines whether or not captured video data is to be transmitted to back end server 50. Specifically, wearable camera 10 determines whether or not the setting for transmitting the captured video data at, for example, predetermined time intervals such as “every 10 seconds” or “every 5 seconds” is made, or the captured video when police officer 3 takes a shooting position is changed for a certain period of time (S32).

When the setting for periodical transmission at predetermined time intervals is made (YES in S32), or the captured video is not changed for a certain period of time (YES in S32), particularly, in the latter case, wearable camera 10 determines that police officer 3 has taken a shooting position, and then transmits the captured video data and a determination request for this captured video data to back end server 50 (S33). Note that, in Step S32, wearable camera 10 may execute the process of step S33 not only when there is no change of the captured video in a certain period of time, but also when the change of the captured video in a certain period of time is less than the predetermined amount. Here, the predetermined amount indicates, for example, the ratio at which a difference value of luminance or RGB value of each pixel in the immediately preceding frame with respect to the entire captured image frames constituting the captured video is equal to or larger than a predetermined value.

When the setting for the transmission at predetermined time intervals is made (NO in S32) or there is the change of the captured video in a certain period of time is greater than the above-described predetermined amount (NO in S32), the process of wearable camera 10 returns to Step S2 (refer to FIG. 6) or Step S5A.

Back end server 50 determines the action of police officer 3 who has wearable camera 10 mounted on the uniform or carries wearable camera 10 by using the captured video data transmitted in Step S33 (512A). The determination of Step S12A is performed depending on the presence or absence of execution of the respective processes of Steps S12A-1, S12A-2, and S12A-3, for example.

Specifically, back end server 50 determines whether or not the captured image when police officer 3 holds pistol GN is included in the captured video data based on the analysis of the captured video data (S12A-1). Back end server 50 generates the recording start instruction of the captured video data (S13) in a case where it is determined that the captured image when police officer 3 holds pistol GN is included in the captured video data (YES in S12A-1). Since the processes from step S13 onwards are the same as those in FIG. 7, the description thereof will not be repeated.

On the other hand, in a case where the captured image when police officer 3 holds the pistol is not included in the captured video data (NO in (S12A-1)), back end server 50 determines whether or not police officer 3 holds pistol GN by confirming whether or not marker MK which is given to pistol GN for detection is included in the captured video based on the analysis of the captured video data (512A-2). Back end server 50 generates the recording start instruction of the captured video data (S13) in a case where it is determined that marker MK which is given to pistol GN for detection is included in the captured video (YES in S12A-2).

On the other hand, in a case where marker MK which is given to pistol GN for detection is not included in the captured video (NO in S12A-2), back end server 50 determines whether or not the arms of police officer 3 holding pistol GN are moved to the shooting position from the lower side by examining the difference from the past captured video data based on the analysis of the continuously received captured video data (S12A-3). Back end server 50 generates the recording start instruction of the captured video data (S13) in a case where it is determined that the arms of police officer 3 holding pistol GN are moved to the shooting position from the lower side (YES in S12A-3).

On the other hand, in a case where it is determined that the arms of police officer 3 holding pistol GN are not moved to the shooting position from the lower side (NO in S12A-3), back end server 50 transmits a response indicating that the police officer does not take the above-described predetermined action (refer to S12A-1, S12A-2, and S12A-3) to wearable camera 10 (S16). Since the processes of wearable camera 10 from Step S16 onwards are the same as those in FIG. 7, the description thereof will not be repeated.

With this, in wearable camera system 5, since back end server 50 can determine that police officer 3 holds pistol GN, the determination can be more accurately performed than in wearable camera 10, unnecessary recording of a large capacity of captured video data can be suppressed, and thereby the recording of essentially necessary captured video data can be performed in wearable camera 10.

In addition, the operation procedure of starting the automatic recording in wearable camera 10 used in the first to third methods as described above will be described with reference to FIG. 11. FIG. 11 is a flowchart specifically illustrating another example of operation procedure of automatic recording in wearable camera 10 of the modification example. In the illustration of FIG. 11, the same step numbers are given to the same processes as those in FIG. 6 or FIG. 9, the explanation will be simplified or not be repeated, and different contents will be described.

In FIG. 11, wearable camera 10 acquires the captured video data of the incident site which is captured by capture 11 (S5A) even in the case where it is determined that the gunshot of pistol GN is not detected (NO in S4). Wearable camera 10 determines the action of police officer 3 who has wearable camera 10 mounted on the uniform or carries wearable camera 10 in analyzer 19y by using the captured video data acquired in Step S5A (S6A). The determination of Step S6A is performed depending on the presence or absence of execution of the respective processes of Steps S6A-1, S6A-2, and S6A-3, for example.

Specifically, wearable camera 10 determines whether or not the captured image when police officer 3 holds pistol GN is included in the captured video data based on the analysis of the captured video data (S6A-1). wearable camera 10 starts to record the captured video data acquired in Step S5A to storage 15 (S7) in a case where it is determined that the captured image when police officer 3 holds pistol GN is included in the captured video data (YES in S6A-1).

On the other hand, in a case where the captured image when police officer 3 holds the pistol is not included in the captured video data (NO in S6A-1), wearable camera 10 determines whether or not police officer 3 holds pistol GN by confirming whether or not marker MK which is given to pistol GN for detection is included in the captured video based on the analysis of the captured video data (S6A-2). Wearable camera 10 starts to record the captured video data acquired in Step S5A to storage 15 (S7) in a case where it is determined that marker MK which is given to pistol GN for detection is included in the captured video (YES in S6A-2).

On the other hand, in a case where marker MK which is given to pistol GN for detection is not included in the captured video (NO in S6A-2), wearable camera 10 determines whether or not the arms of police officer 3 holding pistol GN are moved to the shooting position from the lower side by examining the difference from the past captured video data based on the analysis of the continuously received captured video data (S6A-3). Wearable camera 10 starts to record the captured video data acquired in Step S5A to storage 15 (S7) in a case where it is determined that the arms of police officer 3 holding pistol GN are moved to the shooting position from the lower side (YES in S6A-3).

On the other hand, in a case where it is determined that the arms of police officer 3 holding pistol GN are not moved to the shooting position from the lower side (NO in S6A-3), the process of wearable camera 10 returns to Step S2.

With this, wearable camera 10 can determine the presence or absence of a predetermined action of police officer 3 (for example, police officer 3 holds his or her own pistol GN) by using the captured video data captured by capture 11 without using the acceleration data, and can leave videos capturing interactions between police officer 3 and a suspicious person (for example, the suspect on escape related to the incident).

### Second Embodiment

In the second exemplary embodiment, as an example of an external sensor that is mounted on a portion of a user's body so as to acquire information on an activity level of the user, an example of starting the recording of wearable camera 10 will be described with reference to information measured by using an activity meter. As the information on the activity level of the user which is acquired by the external sensor, information on user's movement, biometric information represented by heart rate, and the like are used.

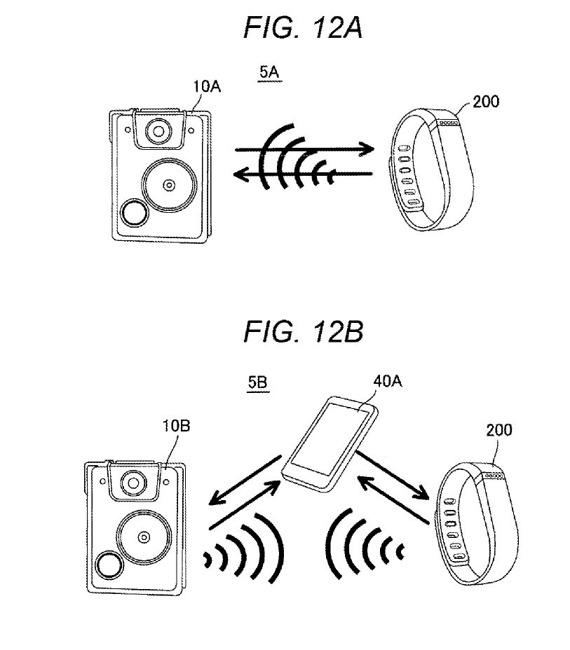

FIG. 12A is diagram illustrating an outline of a first example of the wearable camera system including wearable camera and an activity meter, and FIG. 12B is diagram illustrating an outline of a second example of the wearable camera system including wearable camera, an activity meter, and a smart phone.

Wearable camera system 5A of the first example is configured to include wearable camera 10A and activity meter 200. Wearable camera 10A has the same configuration of that of wearable camera 10 of the first embodiment as illustrated in FIG. 4 except that functions are slightly different. In the following description, the functions different from those in the first embodiment will be described. Activity meter 200 is configured to include a sensor that acquires various pieces of information (information on activity level) on person's activities such as movement, heart rate, sweating, and body temperature of a police officer as a user. Activity meter 200 is mounted, for example, on user's wrist so as to measure the activity level. Details of activity meter 200 will be described below. Wearable camera 10A and activity meter 200 communicate with each other so as to exchange the information acquired by activity meter 200. For the communication between wearable camera 10A and activity meter 200, BLE communication may be used, for example.

Wearable camera system 5B in the second example is configured to include smart phone 40A as an example of wearable camera 10B, activity meter 200, and a communication terminal. Wearable camera 10B has functions slightly different from wearable camera 10A of the first example. Smart phone 40A can communicate with wearable camera 10B and activity meter 200, and wearable camera 10B and activity meter 200 communicate with each other via smart phone 40A so as to transfer the information acquired by activity meter 200. For the communication between wearable camera 10A and smart phone 40A, and the communication between smart phone 40A and activity meter 200, BLE communication may be used, for example.

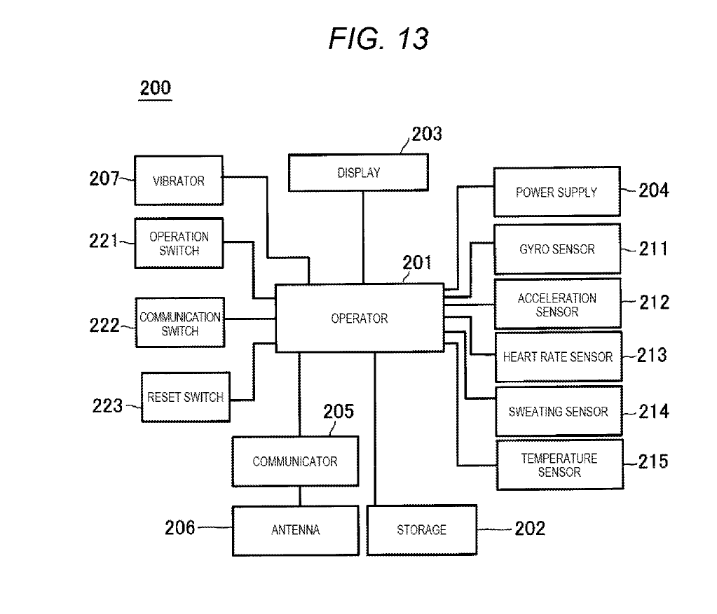

FIG. 13 is a block diagram illustrating an example of internal configuration of activity meter 200. Activity meter 200 is provided with operator 201, storage 202, display 203, power supply 204, communicator 205, antenna 206, and vibrator 207. Activity meter 200 is provided with gyro sensor 211, acceleration sensor 212, heart rate sensor 213, sweating sensor 214, and temperature sensor 215, which are examples of the sensor that measures user's activity level. Activity meter 200 may include at least one of the above-described sensors. Activity meter 200 is provided with operation switch 221, communication switch 222, and reset switch 223.

Operator 201 includes a processing device such as a microprocessor, and performs an arithmetic process on a measured value from output signals indicating a predetermined physical quantity output by the sensor. Operator 201 calculates the activity level such as a predetermined action, heart rate, sweating, and body temperature of the user based on the measured values acquired from the sensor. Storage 202 is configured to include a semiconductor memory such as flash ROM, and stores a program for executing operator 201, and the acquired data such as the measured value and the activity level. Display 203 is configure d to include a display device such as LED and LCD, and displays the operation state of activity meter 200, the acquired activity levels, and the like by turning on or off light, or with characters, images, and the like. Power supply 204 is configured to include a chargeable secondary battery, and supplies power of power source to each part of activity meter 200.

Communicator 205 includes a communication circuit for performing wireless communication such as BLE communication, and exchanges the information on the activity level with wearable camera 10A, or between wearable camera 10B and smart phone 40A. Antenna 206 transmits or receives wireless signal at the time of the communication through communicator 205. Vibrator 207 vibrates at a predetermined timing based on the instruction of operator 201 so as to notify the user of the information.

Gyro sensor 211 detects an angular velocity of activity meter 200. Acceleration sensor 212 detects the acceleration in the three-axis direction of the Cartesian coordinate system of activity meter 200. Operator 201 calculates the information on the activity level on the operations of the user with activity meter 200 mounted on his or her wrist based on the outputs of gyro sensor 211 and acceleration sensor 212. Heart rate sensor 213 includes, for example, a light emitting element and a light receiving element, and measure the heart rate of the user with activity meter 200 mounted on his or her wrist by irradiating the blood vessels in the human body with light to receive the reflected light and detecting the pulse from the fluctuation of the received light amount. Operator 201 calculates the information on the activity level relating to heart rate based on the output of heart rate sensor 213. Sweating sensor 214 detects the sweating of the user with activity meter 200 mounted on his or her wrist based on humidity in the vicinity of the skin or the like. Operator 201 calculates the information on the activity level relating to the sweating such as the presence or absence of sweating or the sweating amount based on the output of sweating sensor 214. Temperature sensor 215 measures the body temperature of the user with activity meter 200 mounted on his or her wrist. Operator 201 calculates the information on the activity level relating to the body temperature such as an increase of the body temperature based on the output of temperature sensor 215.

Operation switch 221 is, for example, a press-button switch for inputting operation instructions such as switching of display contents and switching of operation modes of activity meter 200. Communication switch 222 is, for example, a press-button switch for inputting communication instructions such as start of communication and stop of communication of activity meter 200. Reset switch 223 is, for example, a press-button switch for inputting reset instructions for resetting activity levels measured in activity meter 200, or for resetting various kinds of settings of activity meter 200.

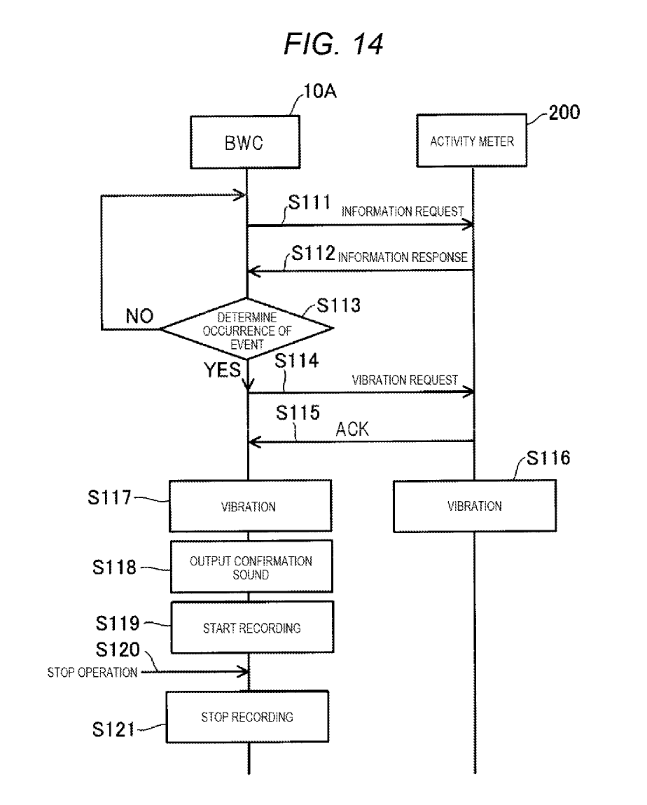

Next, the starting procedure of the automatic recording in wearable camera system of the first example of the second exemplary embodiment will be described with reference to FIG. 14. FIG. 14 is a sequence diagram specifically illustrating an example of operation procedure of automatic recording in the wearable camera system of the first example of the second exemplary embodiment. In FIG. 14, wearable camera 10A is denoted as BWC. In the example, an operation example in which the recording is started without waiting for user confirmation in a case where the occurrence of a predetermined event to start recording is detected by wearable camera 10A and activity meter 200 is described. In the example, MCU 19 provided in wearable camera 10A serves as an example of a determiner and a recording controller.

In FIG. 14, wearable camera 10A transmits an information request of the activity level to activity meter 200 (S111). Activity meter 200 transmits the information response of the activity level to wearable camera 10A when receiving the information request from wearable camera 10A (S112). Wearable camera 10A determines the occurrence of the predetermined event to start recording by receiving the information on the activity level from activity meter 200 (S113).

As a determination condition of the occurrence of the event based on the activity level, detection of specific actions such as an action in which the user (police officer) starts to run, an action in which the user takes out of a pistol from a holster, and an action in which the user is fell down may be used based on the outputs of gyro sensor 211 and acceleration sensor 212. The action of taking out the pistol includes a distinctive action such as an action in which the arms of the user draw a circular arc, and thus can be appropriately detected by using the output of gyro sensor 211 and acceleration sensor 212. For example, in the case where activity meter 200 is mounted on the arm of the user, it is possible to accurately detect the specified operation such as the operation of taking out the pistol. The occurrence of the event relating to the actions of the user may be detected by using the outputs of gyro sensor GY and acceleration sensor AC provided in wearable camera 10A. As another determination condition of the occurrence of the event, detection of an increase in the heart rate or stop of the heart rate of the user based on the output of heart rate sensor 213 may be used. The increase in the heart rate has a high relevance to the situation in which the user (police officer) is in the incident occurrence site such as in a tense state in which the user starts to run, and takes the shooting position with pistol. Stop of the heart rate is supposed to be a situation where the user died. As another determination condition of the occurrence of the event, detection of the sweating of the user based on the output of sweating sensor 214 may be used. Sweating frequently occurs when the user is in a tension state in which the user takes the action of the shooting position, or the activity level of the user is increased. As another determination condition of the occurrence of the event, detection of the increase in the body temperature of the user based on the output of temperature sensor 215 may be used. The increase in the body temperature is assumed to be a state where the activity level of the user is increased.

In a case where it is determined that the event does not occur (NO in S113), wearable camera 10A executes the transmission of the information request of the activity level to activity meter 200 again. In this case, wearable camera 10A repeatedly transmits the information request until the determination of the occurrence of the event is made at a predetermined timing such as every predetermined period. In a case where it is determined that the event occurs (YES in S113), wearable camera 10A transmits a vibration request to activity meter 200 (S114). When receiving the vibration request from wearable camera 10A, activity meter 200 transmits a response of ACKnowledgement (ACK) to wearable camera 10A (S115), and operates vibrator 207 to vibrates a housing (S116). Further, wearable camera 10A operates vibrator 27 of the master device to vibrate the housing (S117). The user can recognizes that the occurrence of the predetermined event is detected based on the activity level of the user with the vibration of activity meter 200 and the vibration of wearable camera 10A.

Wearable camera 10A outputs a predetermined confirmation sound such as “recording is started” (S118). In this case, wearable camera 10A outputs a sound signal of the confirmation sound by sound output 28, and outputs sounds from speaker 29B. Note that, for notification of event detection to the user, either one of notification by vibration and notification by confirmation sound may be performed, or notification may be given by causing the LED to emit light.

Subsequently, wearable camera 10A starts recording captured video data (S119). In this case, wearable camera 10A starts capturing as a subject the front of the police officer who is a user by capture 11, and stores the captured video data in the storage 15. With this, wearable camera 10A can start automatic recording when starting to chase or to be chased by the suspect on escape related to the incident or when the police officer holds the pistol toward suspect based on the activity level acquired by activity meter 200, and thus it is possible to leave videos of the atmosphere of the tense site where the police officer encounters the suspect is detected as evidence videos.

When inputting a stop instruction by operating recording switch SW1 of the user (S120), wearable camera 10A stops the recording of the captured video data (S121).

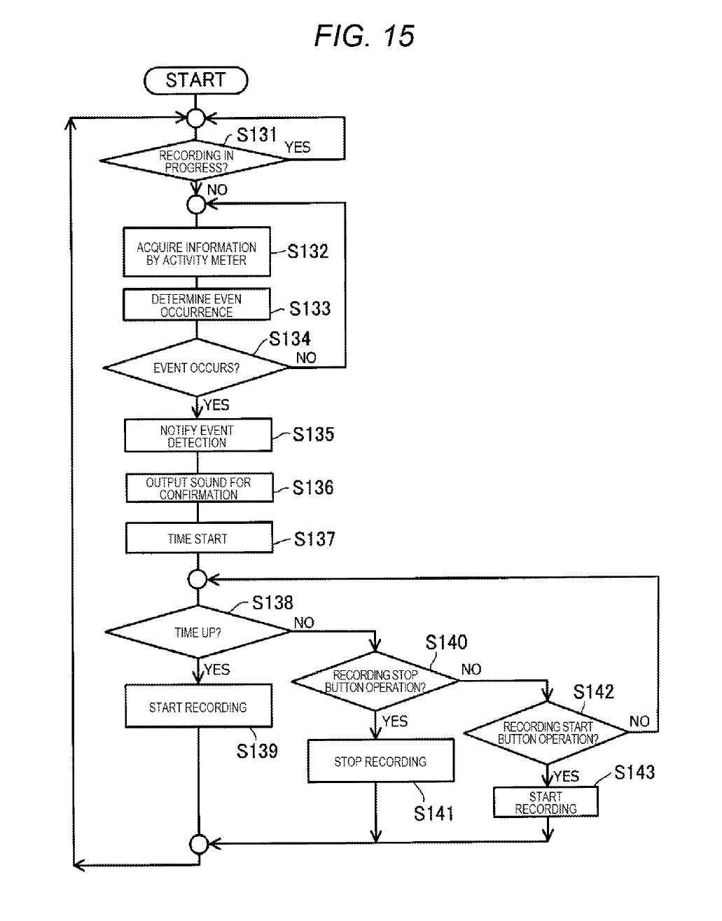

Next, another example of the starting procedure of the automatic recording in the wearable camera system of the first example will be described with reference to FIG. 15. FIG. 15 is a flowchart specifically illustrating an example of operation procedure of automatic recording in the wearable camera system of the first example of the second exemplary embodiment. FIG. 15 mainly illustrates an operation of wearable camera 10A. In the example, an operation example in which the recording is started after waiting for user confirmation in a case where the occurrence of a predetermined event to start recording is detected by wearable camera 10A and activity meter 200 is described.

Regarding FIG. 15, wearable camera 10A determines whether or not the recording is in progress (that is, while the captured video data is stored in storage 15) (S131), and if the recording is not in the progress (NO in S131), the information on the activity level is acquired by activity meter 200 (S132). In addition, wearable camera 10A determines the occurrence of the predetermined event to start recording (S133). The determination condition of the occurrence of the event based on the activity level may be the same as that in the example illustrated in FIG. 14.

Wearable camera 10A determines the presence or absence of the occurrence of the event (S134), and in the case where it is determined that the event does not occur (NO in S134), wearable camera 10A executes information acquisition of the activity level from activity meter 200 again. In this case, wearable camera 10A repeatedly executes the information acquisition until the determination of the occurrence of the event is made at a predetermined timing such as every predetermined period. In a case where it is determined that the event occurs (YES in S134), wearable camera 10A notifies the user of the fact that the event is detected (that is, the occurrence of the predetermined event is detected) (S135). As the notification of the event detection, wearable camera 10A may use methods of operating a vibrator in the master device to vibrate the housing, causing the LED to emit light, and transmitting a vibration request to the activity meter 200 to vibrate.

Further, wearable camera 10A outputs a predetermined confirmation sound such as “recording event is detected, do you want start recording?” (S136). In this case, wearable camera 10A outputs the sound signal of the confirmation sound by sound output 28, and outputs the sound from speaker 29B. In addition, wearable camera 10A starts a timer provided in MCU 19 (S137) and measures a predetermined time until the recording is started. It is preferable that the processes of the event detection notification of S135, confirmation sound output of S136, and timer start of S137 are substantially executed at the same time.

In a power ON state, wearable camera 10A constantly pre-buffers the video data of a predetermined time captured by capture 11, and holds and updates the video data in storage 15. That is, wearable camera 10A continuously stores the video data immediately before the predetermined time before the current time. The pre-buffering time of this predetermined time is, for example, two minutes, and a timer time for timer counting when an event occurs is a time shorter than the pre-buffering time, for example, 10 seconds. Wearable camera 10A determines the presence or absence of an instruction to stop recording by the user in the period of the timer time while pre-buffering is being executed, and in a case where the instruction to stop recording is given, the recording by the occurrence of the event is stopped.

Wearable camera 10A determines whether or not the time is up by counting the timer time after timer start in S137 (S138), and starts the recording of the captured video data in the case where the time is up (S139). In this case, wearable camera 10A starts capturing as a subject the front of the police officer who is a user by capture 11, and stores the captured video data in the storage 15. With this, wearable camera 10A can start automatic recording when a predetermined event based on the activity level acquired by activity meter 200 occurs, and thus it is possible to leave videos of the atmosphere of the tense site where the incident occurs as evidence videos.

Wearable camera 10A determines whether or not the operation (that is, the instruction to stop the recording) of the recording stop button by the press operation of the recording switch SW1 of the user is made before the time is up in the determination of S138 (S140), and in the case where the instruction to stop recording is made, the recording of the captured video data is stopped (S141). With this, in a case where the occurrence of the event based on the information on the activity level is detected in a situation which is not intended by the user such as an action of the user running in a situation which is not related to the incident, detection of the occurrence of the event such as the increase in the heart rate and sweating due to other factors, or false detection of the occurrence of the event, the recording operation can be stopped by the user instruction. The instruction to stop recording by the user may determine that the stop instruction (“No Record” or the like) by the sounds generated by the user is collected by microphone 29A, and MCU 19 recognizes the sound, and thereby the instruction to stop the recording is made.

Wearable camera 10A determines whether or not the operation (that is, the instruction to start the recording) of the recording start button by the press operation of the recording switch SW 1 of the user is made before the time is up in the determination of S138 (S142), and in the case where the instruction to start the recording is made, the recording of the captured video data is started (S143). With this, in a case where the occurrence of the event is detected based on the information on the activity level, the recording operation can be started immediately by the user instruction.

In wearable camera system 5A of the first example of the exemplary embodiment, wearable camera 10A captures a subject on front side of police officer 3 as an example of a user. In addition, the information on the activity level of police officer 3 is acquired in activity meter 200, and the information is transmitted to wearable camera 10A. Wearable camera 10A receives and acquires the information on the activity level from activity meter 200, and determines whether or not a predetermined event to start recording occurs based on the acquired information on the activity level of police officer 3. In a case where it is determined that a predetermined event occurs, the recording of the captured video data is started.

With this, in such a tense situation where police officer 3 chases the suspicious person on escape related to the incident, even if police officer 3 does not operate the manual start of the recording start in person, wearable camera 10A can reduce the missing of the recording by starting the recording of the video captured by wearable camera 10A. Accordingly, wearable camera 10A can efficiently assist police officer 3 with their services.

As a predetermined event, wearable camera 10A determines at least one of an action in which police officer 3 with activity meter 200 mounted on his or her wrist starts to run, an action in which police officer 3 takes action of the shooting position with his or her own pistol, an increase in the heart rate of police officer 3, the sweating of police officer 3, and an increase in the body temperature of police officer 3. With this, wearable camera 10A can start automatic recording in a state where the activity level is increased when, for example, starting to chase or to be chased by the suspect on escape related to the incident, and thus it is possible to leave videos of the atmosphere of the tense site where the police officer encounters the suspect is detected as evidence videos.

In a case where wearable camera 10A determines the instruction to stop recording by the user police officer 3, the recording of the captured video data is stopped. With this, in a case where the occurrence of the event based on the information on the activity level is detected in a situation which is not intended by police officer 3, the recording operation can be stopped.

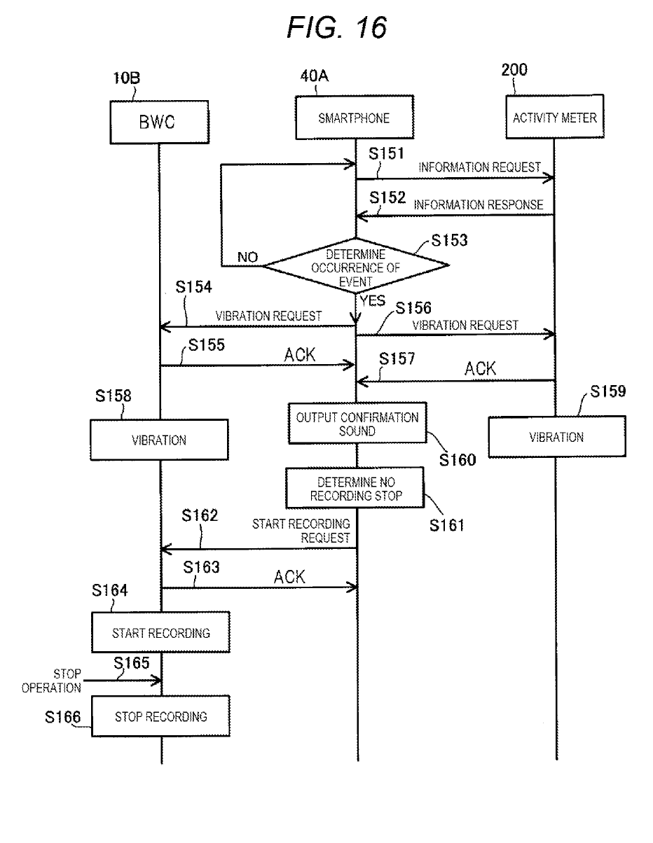

Next, the starting procedure of the automatic recording in the wearable camera system of the second example of the second exemplary embodiment will be described with reference to FIG. 16. FIG. 16 is a sequence diagram specifically illustrating an example of operation procedure of automatic recording in the wearable camera system of the second example of the second exemplary embodiment. In FIG. 16, wearable camera 10B is denoted as BWC. In the example, an operation example in which wearable camera 10B start the recording the occurrence of a predetermined event to start recording is detected by smart phone 40A and activity meter 200 is described.

In FIG. 16, smart phone 40A transmits the information request of the activity level to activity meter 200 (S151). Activity meter 200 transmits the information response of the activity level to smart phone 40A when receiving the information request from smart phone 40A (S152). Smart phone 40A determines the occurrence of the predetermined event to start recording by receiving the information on the activity level from activity meter 200 (S153). The determination condition of the occurrence of the event based on the activity level may be the same as that in the example illustrated in FIG. 14.

In a case where it is determined that the event occurs (NO in S153), smart phone 40A executes the transmission of the information request of the activity level to activity meter 200 again. In this case, smart phone 40A repeatedly transmits the information request until the determination of the occurrence of the event is made at a predetermined timing such as every predetermined period. In the case where it is determined that the event occurs (YES in S153), smart phone 40A transmits a vibration request to wearable camera 10B (S154). When receiving the vibration request from smart phone 40A, wearable camera 10B transmits a response of ACK to smart phone 40A (S155), and operates vibrator 27 to vibrate the housing (S156). In addition, smart phone 40A transmits the vibration request to activity meter 200 (S157). When receiving the vibration request from smart phone 40A, activity meter 200 transmits a response of ACK to smart phone 40A (S158), and operates vibrator 27 to vibrate the housing vibrator 207 (S159). The user can recognizes that the occurrence of the predetermined event is detected based on the activity level of the user with the vibration of activity meter 200 and the vibration of wearable camera 10B.

Smart phone 40A outputs a predetermined confirmation sound such as “recording is started” (S160). Note that, smart phone 40A may notify of the user of the display “recording start” on the display. In addition, smart phone 40A determines that there is no stop condition (no recording stop) of the recording operation such as an instruction to stop recording by the user (S161). This determination of no recording stop can be realized through the same processes as those of Steps S137 to S143 in wearable camera 10A of the example illustrated in FIG. 15. In other words, smart phone 40A determines whether or not there is an instruction to stop recording by the user in a certain period of time after detecting the occurrence of the event, and in the case where there is no instruction to stop the recording, smart phone 40A determines that the recording is not stopped.

When determining that the recording is not stopped, smart phone 40A transmits the recording start request to wearable camera 10B (S162). When receiving a recording start request from smart phone 40A, wearable camera 10B transmits the response of ACK to smart phone 40A (S163), and starts the recording of the captured video data (S164). With this, by using the activity level acquired by activity meter 200, the occurrence of the predetermined event based on the activity level is determined in smart phone 40A, and wearable camera 10B can start automatic recording at the time of the occurrence of the event, and thus it is possible to leave videos of the atmosphere of the tense site where the incident occurs as evidence videos.

As similar to the example illustrated in FIG. 14, when inputting an instruction to stop recording by the operation of recording switch SW1 of the user (S165), wearable camera 10B may perform a recording stop operation such that the recording of the captured video data is stopped (S166). In this case, when the occurrence of the event is detected in a situation which is not intended by the user, and thus recording is not required, the user can instruct the wearable camera 10B to stop the recording. For example, in a situation where since smart phone 40A is in a deep place of a pocket of clothes of police officer 3, it is difficult to take out and operate the smart phone, wearable camera 10B can stop the recording operation by the operation of the user even in a case where the recording stop instruction can be made in response to the notification of the event detection by the violation.

In wearable camera system 5B of the second example of the exemplary embodiment, wearable camera 10B captures a subject on front side of police officer 3 as an example of a user. In addition, the information on the activity level of police officer 3 is acquired in activity meter 200, and the information is transmitted to smart phone 40A as an example of the communication terminal. In addition, smart phone 40A determines whether or not a predetermined event to start recording occurs based on the acquired information on the activity level of police officer 3, and in the case where it is determined that a predetermined event occurs, the recording start instruction for instructing the recording start of the captured video data is transmitted to wearable camera 10B. Wearable camera 10B receives the recording start instruction transmitted from smart phone 40A, and starts the recording of the captured video data in response to the received recording start instruction. In addition, wearable camera 10B stops the recording of the captured video data in the case where the instruction to stop recording by police officer 3 is determined.

With this, in such a tense situation where police officer 3 chases the suspect on escape related to the incident, even if police officer 3 does not operate the manual start of the recording start in person, wearable camera 10B can reduce the missing of the recording by starting the recording of the video captured by wearable camera 10B. In addition, in a case where the occurrence of the event based on the information on the activity level is detected in a situation which is not intended by police officer 3, the recording operation can be stopped.

While various embodiments have been described with reference to the drawings, it goes without saying that the present disclosure is not limited to such examples. It is obvious that various modification examples can be conceived those skilled in the art within the scope described in the claims, and it is understood that the modification examples belong to the technical scope of the present disclosure as well. Further, within the scope not deviating from the purpose of the disclosure, each constituent element in the above embodiment may be arbitrarily combined.

The present disclosure is useful as wearable camera system and a recording control method which efficiently assist police officers with their services by starting recording of a video captured by the wearable camera so as to prevent the recording from missing even if a police officer does not perform a recording operation in person.

What is claimed is:

1. A wearable camera which is mounted on or belongs to a user, comprising:
a capture that captures a subject on a front side of the user;
a sensor that acquires information on a movement of the user;
a determiner that determines whether or not a predetermined action is performed by the user based on information on the movement of the user acquired by the sensor; and
a recording controller that starts recording of the captured video of the subject captured by the capture in a case where the determiner determines that a predetermined action is performed by the user.

2. The wearable camera of claim 1,
wherein the determiner determines whether or not the user starts to run, as the predetermined action.

3. The wearable camera of claim 1,
wherein the determiner determines whether or not the user takes a shooting position with the user's own pistol, as the predetermined action.

4. The wearable camera of claim 1,
wherein the determiner determines whether or not the user is fell down on a ground, as the predetermined action.

5. The wearable camera of claim 1, further comprising:
a microphone that collects a sound,
wherein the determiner determines whether or not the sound collected by the microphone is a gunshot of the pistol.

6. The wearable camera of claim 1, further comprising:
an analyzer that analyzes a captured video of the subject captured by the capture,
wherein the recording controller starts recording the captured video of the subject captured by the capture in a case where it is determined that the user holds the user's own pistol by the analyzer.

7. The wearable camera of claim 6,
wherein the analyzer determines that the user holds the user's own pistol in a case where the user's own pistol and arms gripping the pistol are detected in the captured video of the subject.

8. The wearable camera of claim 6,
wherein the analyzer determines that the user holds the user's own pistol in a case where a marker given to the user's own pistol in advance is detected in the captured video of the subject.

9. The wearable camera of claim 6,
wherein the analyzer determines that the user holds the user's own pistol in a case of detecting that the arms gripping the user's own pistol are moved to a predetermined shooting position in the captured video of the subject.

10. A wearable camera system in which wearable camera which is mounted on or belongs to a user and a server are communicably connected to each other,
wherein the wearable camera captures a subject on the front side of the user, acquires information on a movement of the user, and transmits the acquired information on the movement of the user to the server,
wherein the server receives the information on the movement of the user transmitted from the wearable camera, determines whether or not a predetermined action is performed by the user based on the received information on the movement of the user, and transmits a recording start instruction of the captured video of the subject to the wearable camera in a case where it is determined that a predetermined action is performed by the user, and
wherein the wearable camera receives the recording start instruction transmitted from the server, and starts recording of the captured video of the subject in response to the received recording start instruction.

11. A recording control method in a wearable camera which is mounted on or belongs to a user, the method comprising:
capturing a subject on the front side of the user;
acquiring information on a movement of the user;
determining whether or not a predetermined action is performed by the user based on the acquired information on a movement of the user; and
starting recording the captured video of the subject captured in a case of determining that a predetermined action is performed by the user.

12. A wearable camera which is mounted on or belongs to a user, comprising:
a capture that captures a subject on the front side of the user;
a communicator that communicates with an external sensor that acquires information on an activity level of the user;
a determiner that determines whether or not a predetermined event occurs based on the information on the activity level of the user received from the external sensor by the communicator; and
a recording controller that starts recording of the captured video of the subject captured by the capture in a case of determining the predetermined event occurs by the determiner.

13. The wearable camera of claim 12,
wherein the external sensor is an activity meter that acquires the information of the activity level of the user.

14. The wearable camera of claim 12,
wherein as the predetermined event, the determiner determines at least one of an action in which the user starts to run, an action in which the user takes action of the shooting position with his or her own pistol, an increase in a heart rate of the user, sweating of the user, and an increase in a body temperature of the user.

15. The wearable camera of claim 12,
wherein the recording controller stops recording the captured video of the subject in a case of determining recording stop by an instruction of the user.

16. A wearable camera system in which a wearable camera which is mounted on or belongs to a user and an external sensor that acquires an activity level of the user are communicably connected to each other,
wherein the wearable camera captures a subject on the front side of the user,
wherein the external sensor acquires information on an activity level of the user, and transmits the acquired information on the activity level of the user to the wearable camera, and
wherein the wearable camera receives the information on the activity level of the user transmitted from the external sensor, determines whether or not a predetermined event occurs based on the received information on the activity level of the user, and starts recording of the captured video of the subject in a case of determining that the predetermined event occurs.

17. A wearable camera in a wearable camera system in which the wearable camera which is mounted on or belongs to a user, an external sensor that acquires an activity level of the user, and a communication terminal are communicably connected to each other,
wherein the external sensor acquires information on the activity level of the user, and transmits the acquired information on the activity level of the user to the communication terminal,
wherein the communication terminal receives the information on the activity level of the user transmitted from the external sensor, determines whether or not a predetermined event occurs based on received the information on the activity level of the user, and transmits a recording start instruction of a captured video of the subject in a case where it is determined that the predetermined event occurs to the wearable camera, and
wherein the wearable camera captures a subject on the front side of the user, receives the recording start instruction transmitted from the communication terminal, starts recording of the captured video of the subject in response to the received recording start instruction, and stops the recording of the captured video of the subject in a case where it is determined that the recording stop is determined by an instruction of the user.
